(19) United States
(12) Patent Application Publication
(10) Pub. No.: US 2026/0244000 A1
(43) Pub. Date: Aug. 20, 2026

(54) LENS ASSEMBLY

(71) Applicant: Asia Optical Co., Inc., Taichung (TW)

(72) Inventors: Wen-Chieh Chen, Taichung (TW); Li-Kai Wang, Taichung (TW)

(21) Appl. No.: 19/531,901

(22) Filed: Feb. 6, 2026

(30) Foreign Application Priority Data
Feb. 17, 2025 (TW) 114105743
Apr. 28, 2025 (TW) 114115941

(51) Int. Cl. G02B 13/00; G02B 3/00; G02B 7/02; G02B 9/62

(52) U.S. Cl. CPC G02B 13/0045; G02B 7/025; G02B 9/62; G02B 13/006; G02B 2003/0093

(57) ABSTRACT

A lens assembly includes a first lens, a second lens, a third lens, a fourth lens, a fifth lens, and a sixth lens, all of which are arranged in order from an object side to an image side along an optical axis. The first lens is a meniscus lens with negative refractive power and includes a convex surface facing an object side and a concave surface facing an image side. The fourth lens is with negative refractive power and includes a concave surface facing the object side. The fifth lens is with positive refractive power and includes a convex surface facing the image side. The sixth lens is with positive refractive power and includes a convex surface facing the object side. The first, second, third, fourth, fifth, and sixth lenses are arranged in order from the object side to the image side along an optical axis.

### BACKGROUND OF THE INVENTION

### Field of the Invention

The present invention relates to a lens assembly.

### Description of the Related Art

The current development trend of a lens assembly is toward high resolution. Additionally, the lens assembly is developed to have large aperture to meet the requirement of capturing image both day and night in accordance with different application requirements. However, the known lens assembly can't satisfy such requirements. Therefore, the lens assembly needs a new structure in order to meet the requirements of high resolution, large aperture, and capturing images both day and night.

### BRIEF SUMMARY OF THE INVENTION

The invention provides a lens assembly to solve the above problems. The lens assembly of the invention is provided with characteristics of an increased resolution, a decreased F-number, and capturing clear images both day and night.

The lens assembly in accordance with an exemplary embodiment of the invention includes a first lens, a second lens, a third lens, a fourth lens, a fifth lens, and a sixth lens. The first lens is a meniscus lens with negative refractive power and includes a convex surface facing an object side and a concave surface facing an image side. The second lens is with refractive power. The third lens is with refractive power. The fourth lens is with negative refractive power and includes a concave surface facing the object side. The fifth lens is with positive refractive power and includes a convex surface facing the image side. The sixth lens is with positive refractive power and includes a convex surface facing the object side. The first lens, the second lens, the third lens, the fourth lens, the fifth lens, and the sixth lens are arranged in order from the object side to the image side along an optical axis. The lens assembly satisfies at least one of the following conditions: −3≤(3.304−f×tan(θ))×TTL/(f×tan(θ))≤−2.4; 0.7≤f5/f≤1.1; 10 mm≤f23≤16 mm; 1.11≤BFL/f≤1.21; 8.32 mm≤T4+T5+T6≤12.16 mm; 2.07≤R42/T4≤2.93; 8.54 degree/mm≤FOV/f≤8.68 degree/mm; 10<(|f6×R62|)^{0.5}/(T3)<32; 41 mm<f5/(T4/T3)<120 mm; wherein f is an effective focal length of the lens assembly, f5 is an effective focal length of the fifth lens, f6 is an effective focal length of the sixth lens, f23 is a combined effective focal length of the combination of the second lens and the third lens, T3 is an interval from an object side surface of the third lens to an image side surface of the third lens along the optical axis, T4 is an interval from an object side surface of the fourth lens to an image side surface of the fourth lens along the optical axis, T5 is an interval from an object side surface of the fifth lens to an image side surface of the fifth lens along the optical axis, T6 is an interval from an object side surface of the sixth lens to an image side surface of the sixth lens along the optical axis, R42 is a radius of curvature of the image side surface of the fourth lens, R62 is a radius of curvature of the image side surface of the sixth lens, TTL is an interval from an object side surface of the first lens to an image plane along the optical axis, BFL is an interval from the image side surface of the sixth lens to the image plane along the optical axis, θ is a field of view when an image height of the lens assembly is equal to 3.304 mm, and FOV is a full field of view of the lens assembly. A lens assembly of the present invention can achieve basic operation when the lens assembly satisfies the above features and at least one of the above conditions, and does not need other additional features or conditions.

In another exemplary embodiment, the fourth lens is a biconcave lens and further includes another concave surface facing the image side; the fifth lens is a biconvex lens and further includes another convex surface facing the object side; and the sixth lens is a biconvex lens and further includes another convex surface facing the image side.

In yet another exemplary embodiment, the third lens is with positive refractive power and includes a convex surface facing the object side.

In another exemplary embodiment, the second lens is a meniscus lens with negative refractive power and includes a convex surface facing the object side and a concave surface facing the image side; and the third lens is a meniscus lens and further includes a concave surface facing the image side.

In yet another exemplary embodiment, the second lens is a meniscus lens with negative refractive power and includes a convex surface facing the object side and a concave surface facing the image side; and the third lens is a biconvex lens and further includes another convex surface facing the image side.

In another exemplary embodiment, the second lens is a meniscus lens with negative refractive power and includes a concave surface facing the object side and a convex surface facing the image side; and the third lens is a biconvex lens and further includes another convex surface facing the image side.

In yet another exemplary embodiment, the second lens is a meniscus lens with negative refractive power and includes a convex surface facing the object side and a concave surface facing the image side; and the third lens is a plano-convex lens and further includes a plane surface facing the image side.

In another exemplary embodiment, the second lens is a biconvex lens with positive refractive power and includes a convex surface facing the object side and another convex surface facing the image side; and the third lens is a meniscus lens and further includes a concave surface facing the image side.

In yet another exemplary embodiment, the second lens is a biconvex lens with positive refractive power and includes a convex surface facing the object side and another convex surface facing the image side.

In another exemplary embodiment, the third lens is a biconcave lens with negative refractive power and includes a concave surface facing the object side and another concave surface facing the image side.

In yet another exemplary embodiment, the fourth lens and the fifth lens are cemented or there is no air gap between the fourth lens and the fifth lens.

In another exemplary embodiment, the second lens and the third lens are cemented or there is no air gap between the second lens and the third lens.

In yet another exemplary embodiment, the lens assembly satisfies at least one of the following conditions: 1.5≤(Vd1+Vd2)/|Vd1−Vd2|≤5.5; 2≤(Vd2+Vd3)/|Vd2−Vd3|≤2.7; 1.5≤(Vd4+Vd5)/|Vd4−Vd5|≤2.5; 1.3≤f6/f≤1.8; 1.5 mm≤T4/Nd4≤1.9 mm; 3.6 mm≤BFL/Nd6≤4.1 mm; 0.08≤(R11−R12)/TTL≤0.31; 304.47≤TTL/d56≤318.48; −16 mm<(R11/R41)×T5<−1 mm; 12 mm<(R21×R62)^{0.5}<141 mm; 5 mm⁻¹<Vd1/T1<118 mm⁻¹; −13<(R11+R22)/T1<80; 28 mm<(d12/T2)×R42<53 mm; 25 mm<(R11−R62)/Nd2<88 mm; −45 mm²<(f2+f5)×T3<135 mm²; 19 mm<(R41×R62)^{0.5}<39 mm; wherein f6 is the effective focal length of the sixth lens, f is the effective focal length of the lens assembly, T4 is the interval from the object side surface of the fourth lens to the image side surface of the fourth lens along the optical axis, Vd1 is an Abbe number of the first lens, Vd2 is an Abbe number of the second lens, Vd3 is an Abbe number of the third lens, Vd4 is 100 an Abbe number of the fourth lens, Vd5 is an Abbe number of the fifth lens, Nd4 is a refractive index of the fourth lens, Nd6 is a refractive index of the sixth lens, TTL is the interval from the object side surface of the first lens to the image plane along the optical axis, BFL is the interval from the image side surface of the sixth lens to the image plane along the optical axis, T1 is an interval from the object side surface of the first lens to an image side surface of the first lens along the optical axis, T2 is an interval from an object side surface of the second lens to an image side surface of the second lens along the optical axis, T3 is the interval from the object side surface of the third lens to the image side surface of the third lens along the optical axis, T5 is the interval from the object side surface of the fifth lens to the image side surface of the fifth lens along the optical axis, d56 is an air interval from the image side surface of the fifth lens to the object side surface of the sixth lens along the optical axis, d12 is an air interval from the image side surface of the first lens to the object side surface of the second lens along the optical axis, R11 is a radius of curvature of the object side surface of the first lens, R12 is a radius of curvature of the image side surface of the first lens, R21 is a radius of curvature of the object side surface of the second lens, R22 is a radius of curvature of the image side surface of the second lens, R41 is a radius of curvature of the object side surface of the fourth lens, R42 is the radius of curvature of the image side surface of the fourth lens, R62 is the radius of curvature of the image side surface of the sixth lens, f2 is an effective focal length of the second 120 lens, f5 is the effective focal length of the fifth lens, and Nd2 is a refractive index of the second lens.

The lens assembly in accordance with another exemplary embodiment of the invention includes a first lens, a second lens, a third lens, a fourth lens, a fifth lens, and a sixth lens. The first lens is a meniscus lens with negative refractive power and includes a convex surface facing an object side and a concave surface facing an image side. The second lens is with positive refractive power. The third lens is with negative refractive power. The fourth lens is with negative refractive power and includes a concave surface facing the object side. The fifth lens is with positive refractive power and includes a convex surface facing the image side. The sixth lens is with positive refractive power and includes a convex surface facing the object side. The first lens, the second lens, the third lens, the fourth lens, the fifth lens, and the sixth lens are arranged in order from the object side to the image side along an optical axis. A lens assembly of the present invention can achieve basic operation when the lens assembly satisfies the above features and does not need other additional features or conditions.

In another exemplary embodiment, the second lens is a biconvex lens and includes a convex surface facing the object side and another convex surface facing the image side; the third lens is a biconcave lens and includes a concave surface facing the object side and another concave surface facing the image side; the fourth lens is a biconcave lens and further includes another concave surface facing the image side; the fifth lens is a biconvex lens and further includes another convex surface facing the object side; and the sixth lens is a biconvex lens and further includes another convex surface facing the image side.

In yet another exemplary embodiment, the second lens and the third lens are cemented or there is no air gap between the second lens and the third lens; and the fourth lens and the fifth lens are cemented or there is no air gap between the fourth lens and the fifth lens.

In another exemplary embodiment, the lens assembly satisfies at least one of the following conditions: −3≤(3.304−f×tan(θ))×TTL/(f×tan(θ))≤≤−2.4; 1.5≤(Vd1+Vd2)/|Vd1−Vd2|≤5.5; 2≤(Vd2+Vd3)/|Vd2−Vd3|≤2.7; 1.5≤(Vd4+Vd5)/|Vd4−Vd5|≤2.5; 0.7≤f5/f≤1.1; 1.3≤f6/f≤1.8; 10 mm≤f23≤16 mm; 1.5 mm≤T4/Nd4≤1.9 mm; 3.6 mm≤BFL/Nd6≤4.1 mm; 1.11≤BFL/f≤1.21; 8.32 mm≤T4+T5+T6≤12.16 mm; 0.08≤(R11−R12)/TTL≤0.31; 2.07≤R42/T4≤2.93; 304.47≤TTL/d56≤318.48; 8.54 degree/mm≤FOV/f≤8.68 degree/mm; −16 mm<(R11/R41)×T5<−1 mm; 12 mm<(R21×R62)^{0.5}<141 mm; 5 mm⁻¹<Vd1/T1<118 mm⁻¹; 10<(|f6×R62|)^{0.5}/(T3)<32; −13<(R11+R22)/T1<80; 41 mm<f5/(T4/T3)<120 mm; 28 mm<(d12/T2)×R42<53 mm; 25 mm<(R11−R62)/Nd2<88 mm; −45 mm²<(f2+f5)×T3<135 mm²; 19 mm<(R41×R62)^{0.5}<39 mm; wherein f is an effective focal length of the lens assembly, f5 is an effective focal length of the fifth lens, f6 is an effective focal length of the sixth lens, f23 is a combined effective focal length of the combination of the second lens and the third lens, T3 is an interval from an object side surface of the third lens to an image side surface of the third lens along the optical axis, T4 is an interval from an object side surface of the fourth lens to an image side surface of the fourth lens along the optical axis, T5 is an interval from an object side surface of the fifth lens to an image side surface of the fifth lens along the optical axis, T6 is an interval from an object side surface of the sixth lens to an image side surface of the sixth lens along the optical axis, R42 is a radius of curvature of the image side surface of the fourth lens, R62 is a radius of curvature of the image side surface of the sixth lens, TTL is an interval from an object side surface of the first lens to an image plane along the optical axis, BFL is an interval from the image side surface of the sixth lens to the image plane along the optical axis, θ is a field of view when an image height of the lens assembly is equal to 3.304 mm, FOV is a full field of view of the lens assembly, Vd1 is an Abbe number of the first lens, Vd2 is an Abbe number of the second lens, Vd3 is an Abbe number of the third lens, Vd4 is an Abbe number of the fourth lens, Vd5 is an Abbe number of the fifth lens, Nd4 is a refractive index of the fourth lens, Nd6 is a refractive index of the sixth lens, T1 is an interval from the object side surface of the first lens to an image side surface of the first lens along the optical axis, T2 is an interval from an object side surface of the second lens to an image side surface of the second lens along the optical axis, d56 is an air interval from the image side surface of the fifth lens to the object side surface of the sixth lens along the optical axis, d12 is an air interval from the image side surface of the first lens to the object side surface of the second lens along the optical axis, R11 is a radius of curvature of the object side surface of the first lens, R12 is a radius of curvature of the image side surface of the first lens, R21 is a radius of curvature of the object side surface of the second lens, R22 is a radius of curvature of the image side surface of the second lens, R41 is a radius of curvature of the object side surface of the fourth lens, f2 is an effective focal length of the second lens, and Nd2 is a refractive index of the second lens.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1, 6, 11 are lens layout diagrams of a lens assembly in accordance with a first, a second, and a third embodiments of the invention, respectively;

FIGS. 2, 3, 4, 5 depict a longitudinal aberration diagram, a field curvature diagram, a distortion diagram, and a lateral color diagram of the lens assembly in accordance with the first embodiment of the invention, respectively;

FIGS. 7, 8, 9, 10 depict a longitudinal aberration diagram, a field curvature diagram, a distortion diagram, and a lateral color diagram of the lens assembly in accordance with the second embodiment of the invention, respectively;

FIGS. 12, 13, 14, 15 depict a longitudinal aberration diagram, a field curvature diagram, a distortion diagram, and a lateral color diagram of the lens assembly in accordance with the third embodiment of the invention, respectively;

FIGS. 16, 21, 22, 23, 28 are lens layout and optical path diagrams of a lens assembly in accordance with a fourth, a fifth, a sixth, a seventh, and an eighth embodiments of the invention, respectively;

FIGS. 17, 18, 19, 20 depict a longitudinal aberration diagram, a field curvature diagram, a distortion diagram, and a relative illumination diagram of the lens assembly in accordance with the fourth embodiment of the invention, respectively;

FIGS. 24, 25, 26, 27 depict a longitudinal aberration diagram, a field curvature diagram, a distortion diagram, and a relative illumination diagram of the lens assembly in accordance with the seventh embodiment of the invention, respectively; and

FIGS. 29, 30, 31, 32 depict a longitudinal aberration diagram, a field curvature diagram, a distortion diagram, and a relative illumination diagram of the lens assembly in accordance with the eighth embodiment of the invention, respectively.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides a lens assembly including a first lens, a second lens, a third lens, a fourth lens, a fifth lens, and, a sixth lens. The first lens is a meniscus lens with negative refractive power and includes a convex surface facing an object side and a concave surface facing an image side. The second lens is with refractive power. The third lens is with refractive power. The fourth lens is with negative refractive power and includes a concave surface facing the object side. The fifth lens is with positive refractive power and includes a convex surface facing the image side. The sixth lens is with positive refractive power and includes a convex surface facing the object side. The first lens, the second lens, the third lens, the fourth lens, the fifth lens, and the sixth lens are arranged in order from the object side to the image side along an optical axis. The lens assembly satisfies at least one of the following conditions: −3≤(3.304−f×tan(θ))×TTL/(f×tan(θ))≤−2.4; 0.7≤f5/f≤1.1; 10 mm≤f23≤16 mm; 1.11≤BFL/f≤1.21; 8.32 mm≤T4+T5+T6≤12.16 mm; 2.07≤R42/T4≤2.93; 8.54 degree/mm≤FOV/f≤8.68 degree/mm; 10<(|f6×R62|)^{0.5}/(T3)<32; 41 mm<f5/(T4/T3)<120 mm; wherein f is an effective focal length of the lens assembly, f5 is an effective focal length of the fifth lens, f6 is an effective focal length of the sixth lens, f23 is a combined effective focal length of the combination of the second lens and the third lens, T3 is an interval from an object side surface of the third lens to an image side surface of the third lens along the optical axis, T4 is an interval from an object side surface of the fourth lens to an image side surface of the fourth lens along the optical axis, T5 is an interval from an object side surface of the fifth lens to an image side surface of the fifth lens along the optical axis, T6 is an interval from an object side surface of the sixth lens to an image side surface of the sixth lens along the optical axis, R42 is a radius of curvature of the image side surface of the fourth lens, R62 is a radius of curvature of the image side surface of the sixth lens, TTL is an interval from an object side surface of the first lens to an image plane along the optical axis, BFL is an interval from the image side surface of the sixth lens to the image plane along the optical axis, θ is a field of view when an image height of the lens assembly is equal to 3.304 mm, and FOV is a full field of view of the lens assembly. A lens assembly of the present invention is a preferred embodiment when the lens assembly satisfies the above features and at least one of the conditions.

The present invention provides another lens assembly including a first lens, a second lens, a third lens, a fourth lens, a fifth lens, and, a sixth lens. The first lens is a meniscus lens with negative refractive power and includes a convex surface facing an object side and a concave surface facing an image side. The second lens is with positive refractive power. The third lens is with negative refractive power. The fourth lens is with negative refractive power and includes a concave surface facing the object side. The fifth lens is with positive refractive power and includes a convex surface facing the image side. The sixth lens is with positive refractive power and includes a convex surface facing the object side. The first lens, the second lens, the third lens, the fourth lens, the fifth lens, and the sixth lens are arranged in order from the object side to the image side along an optical axis. A lens assembly of the present invention is a preferred embodiment when the lens assembly satisfies the above features.

Referring to Table 1, Table 3, and Table 5, wherein Table 1, Table 3, and Table 5 show optical specification in accordance with a first, a second, and a third embodiments of the invention, respectively.

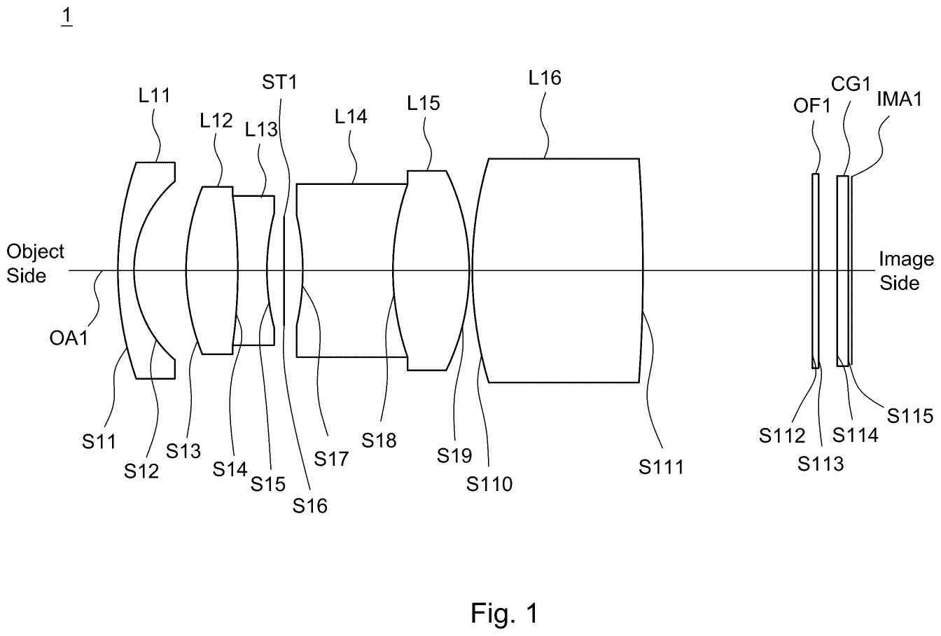

FIGS. 1, 6, 11 are lens layout diagrams of the lens assemblies in accordance with the first, second, and third embodiments of the invention, respectively.

The first lenses L11, L21, L31 are meniscus lenses with negative refractive power and made of glass material, wherein the object side surfaces S11, S21, S31 are convex surfaces, the image side surfaces S12, S22, S32 are concave surfaces, and both of the object side surfaces S11, S21, S31 and image side surfaces S12, S22, S32 are spherical surfaces.

The second lenses L12, L22, L32 are with refractive power and made of glass material, wherein the object side surfaces S13, S23, S33 are convex surfaces, and both of the object side surfaces S13, S23, S33 and image side surfaces S14, S24, S34 are spherical surfaces.

The third lenses L13, L23, L33 are with refractive power and made of glass material, wherein both of the object side surfaces S14, S24, S35 and image side surfaces S15, S25, S36 are spherical surfaces.

The fourth lenses L14, L24, L34 are biconcave lenses with negative refractive power and made of glass material, wherein the object side surfaces S17, S27, S38 are concave surfaces, the image side surfaces S18, S28, S39 are concave surfaces, and both of the object side surfaces S17, S27, S38 and image side surfaces S18, S28, S39 are aspheric surfaces.

The fifth lenses L15, L25, L35 are biconvex lenses with positive refractive power and made of glass material, wherein the object side surfaces S18, S28, S39 are convex surfaces, the image side surfaces S19, S29, S310 are convex surfaces, and both of the object side surfaces S18, S28, S39 and image side surfaces S19, S29, S310 are spherical surfaces.

The fourth lenses L14, L24, L34 and the fifth lenses L15, L25, L35 are cemented or there is no air gap between the fourth lenses L14, L24, L34 and the fifth lenses L15, L25, L35, respectively.

The sixth lenses L16, L26, L36 are biconvex lenses with positive refractive power and made of glass material, wherein the object side surfaces S110, S210, S311 are convex surfaces, the image side surfaces S111, S211, S312 are convex surfaces, and both of the object side surfaces S110, S210, S311 and image side surfaces S111, S211, S312 are spherical surfaces.

In addition, the lens assemblies 1, 2, and 3 satisfy at least one of the following conditions (1)-(15):

$$- 3 \leq ( 3.304 - f \times tan ( θ ) ) \times TTL / ( f \times tan ( θ ) ) \leq - 2.4 ; \qquad ( 1 )$$

$$1.5 \leq ( Vd 1 + Vd 2 ) / \vert Vd 1 - Vd 2 \vert \leq 5.5 ; \qquad ( 2 )$$

$$2 \leq ( Vd 2 + Vd 3 ) / \vert Vd 2 - Vd 3 \vert \leq 2.7 ; \qquad ( 3 )$$

$$1.5 \leq ( Vd 4 + Vd 5 ) / \vert Vd 4 - Vd 5 \vert \leq 2.5 ; \qquad ( 4 )$$

$$0.7 \leq f 5 / f \leq 1.1 ; \qquad ( 5 )$$

$$1.3 \leq f 6 / f \leq 1.8 ; \qquad ( 6 )$$

$$10 mm \leq f 23 \leq 16 mm ; \qquad ( 7 )$$

$$1.5 mm \leq T 4 / Nd 4 \leq 1.9 mm ; \qquad ( 8 )$$

$$3.6 mm \leq BFL / Nd 6 \leq 4.1 mm \qquad ( 9 )$$

$$1.11 \leq BFL / f \leq 1.21 ; \qquad ( 10 )$$

$$8.32 mm \leq T 4 + T 5 + T 6 \leq 12.16 mm ; \qquad ( 11 )$$

$$0.08 \leq ( R 11 - R 12 ) / TTL \leq 0.31 ; \qquad ( 12 )$$

$$2.07 \leq R 42 / T 4 \leq 2.93 ; \qquad ( 13 )$$

$$304.47 \leq TTL / d 56 \leq 318.48 ; \qquad ( 14 )$$

$$8.54 degree / mm \leq FOV / f \leq 8.68 degree / mm ; \qquad ( 15 )$$

wherein the parameters in the first to third embodiments are defined as follows: f is an effective focal length of the lens assemblies 1, 2, 3; f5 is an effective focal length of the fifth lenses L15, L25, L35; f6 is an effective focal length of the sixth lenses L16, L26, L36; f23 is a combined effective focal length of the combination of the second lenses L12, L22, L32 and the third lenses L13, L23, L33; T4 is an interval from the object side surfaces S17, S27, S38 of the fourth lenses L14, L24, L34 to the image side surfaces L18, L28, L39 of the fourth lenses L14, L24, L34 along the optical axes OA1, OA2, OA3; T5 is an interval from the object side surfaces S18, S28, S39 of the fifth lenses L15, L25, L35 to the image side surfaces L19, L29, L310 of the fifth lenses L15, L25, L35 along the optical axes OA1, OA2, OA3; T6 is an interval from the object side surfaces S110, S210, S311 of the sixth lenses L16, L26, L36 to the image side surfaces L111, L211, L312 of the sixth lenses L16, L26, 335 L36 along the optical axes OA1, OA2, OA3; R11 is a radius of curvature of the object side surfaces S11, S21, S31 of the first lenses L11, L21, L31; R12 is a radius of curvature of the image side surfaces S12, S22, S32 of the first lenses L11, L21, L31; R42 is a radius of curvature of the image side surfaces S18, S28, S39 of the fourth lenses L14, L24, L34; d56 is an air interval from the image side surfaces S19, S29, 340 S310 of the fifth lenses L15, L25, L35 to the object side surfaces L110, L210, L311 of the sixth lenses L16, L26, L36 along the optical axes OA1, OA2, OA3; TTL is an interval from the object side surfaces S11, S21, S31 of the first lenses L11, L21, L31 to the image planes IMA1, IMA2, IMA3 along the optical axes OA1, OA2, OA3; BFL is an interval from the image side surfaces S111, S211, S312 of the sixth lenses L16, L26, L36 to the image planes IMA1, IMA2, IMA3 along the optical axes OA1, OA2, OA3; Vd1 is an Abbe number of the first lenses L11, L21, L31; Vd2 is an Abbe number of the second lenses L12, L22, L32; Vd3 is an Abbe number of the third lenses L13, L23, L33; Vd4 is an Abbe number of the fourth lenses L14, L24, L34; Vd5 is an Abbe number of the fifth lenses L15, L25, L35; Nd4 is a refractive index of the fourth lenses L14, L24, L34; Nd6 is a refractive index of the sixth lenses L16, L26, L36; θ is a field of view when the image height of the lens assemblies 1, 2, 3 is equal to 3.304 mm; and FOV is a full field of view of the lens assemblies 1, 2, 3. Making the lens assemblies 1, 2, and 3 decreasing the total lens length effectively, increasing the field of view effectively, decreasing the F-number effectively, increasing the resolution effectively, and correcting the aberration effectively.

When the conditions (1), (5), (7), (10), (11), (12), (13), (15): −3≤(3.304−f×tan(θ))×TTL/(f×tan(θ))≤−2.4, 0.7≤f5/f≤1.1, 10 mm≤f23≤16 mm, 1.11≤BFL/f≤1.21, 8.32 mm≤T4+T5+T6≤12.16 mm, 0.08≤(R11−R12)/TTL≤0.31, 2.07≤R42/T4≤2.93, 8.54 degree/mm≤FOV/f≤8.68 degree/mm are satisfied and the second lens has the opposite refractive power to the third lens, the total lens length can be effectively decreased and has good optical performance.

When the condition (1): −3≤(3.304−f×tan(θ))×TTL/(f×tan(θ))≤−2.4 is satisfied, the distortion can be effectively corrected. When the condition (2): 1.5≤(Vd1+Vd2)/|Vd1−Vd2|≤5.5 is satisfied, the lateral color can be effectively corrected. When the condition (3): 2≤(Vd2+Vd3)/|Vd2−Vd3|≤2.7 is satisfied, the lateral color can be effectively corrected. When the condition (4): 1.5≤(Vd4+Vd5)/|Vd4−Vd5|≤2.5 is satisfied, the lateral color can be effectively corrected. When the condition (5): 0.7≤f5/f≤1.1 is satisfied, the sensitivity of the fifth lens can be effectively reduced. When the condition (6): 1.3≤f6/f≤1.8 is satisfied, the sensitivity of the sixth lens can be effectively reduced. When the condition (7): 10 mm≤f23≤16 mm is satisfied, the sensitivity of the second lens and third lens can be effectively reduced. When the condition (8): 1.5 mm≤T4/Nd4≤1.9 mm is satisfied, the field curvature of the peripheral field of view (sagittal direction) can be effectively decreased. When the condition (9): 3.6 mm≤BFL/Nd6≤4.1 mm is satisfied, the field curvature of the peripheral field of view (sagittal direction) can be effectively decreased.

A detailed description of a lens assembly in accordance with a first embodiment of the invention is as follows. Referring to FIG. 1, the lens assembly 1 includes a first lens L11, a second lens L12, a third lens L13, a stop ST1, a fourth lens L14, a fifth lens L15, a sixth lens L16, an optical filter OF1, and a cover glass CG1, all of which are arranged in order from an object side to an image side along an optical axis OAL. In operation, the light from the object side is imaged on an image plane IMA1.

According to the foregoing, wherein: the second lens L12 is a biconvex lens with positive refractive power, wherein the image side surface S14 is a convex surface; the third lens L13 is a biconcave lens with negative refractive power, wherein the object side surface S14 is a concave surface and the image side surface S15 is a concave surface; the second lens L12 and the third lens L13 are cemented or there is no air gap between the second lens L12 and the third lens L13; both of the object side surface S112 and image side surface S113 of the optical filter OF1 are plane surfaces; both of the object side surface S114 and image side surface S115 of the cover glass CG1 are plane surfaces; with the above design of the lenses, stop ST1, and at least one of the conditions (1)-(15) are satisfied, the lens assembly 1 can have an effective decreased total lens length, an effective increased field of view, an effective decreased F-umber, an effective increased resolution, and an effective corrected aberration. The lens assembly 1 of the present invention can meet basic operation requirements when the lens assembly 1 only satisfies conditions (1), (11), or (15); the first lens is with positive refractive power includes a convex surface facing the object side and a concave surface facing the image side; the second lens is with refractive power; the third lens is with refractive power; the fourth lens is with negative refractive power and includes a concave surface facing the image side; the fifth lens is with positive refractive power and includes a convex surface facing the object side; and the sixth lens is with positive refractive power and includes a convex surface facing the object side.

Table 1 shows the optical specification of the lens assembly 1 in FIG. 1.

TABLE 1
Effective Focal Length = 6.70 mm F-number = 1.87
Total Lens Length = 26.06 mm Full Field of View = 58.00 degrees

| | Radius of | | | | Effective | |
|---|---|---|---|---|---|---|
| Surface | Curvature | Thickness | | | Focal | |
| Number | (mm) | (mm) | Nd | Vd | Length (mm) | Remark |
| S11 | 11.66 | 0.56 | 1.50 | 66.02 | −13.22 | L11 |
| S12 | 4.16 | 1.85 | | | | |
| S13 | 7.92 | 1.85 | 1.81 | 22.76 | 7.02 | L12 |
| S14 | −18.41 | 1.03 | 1.50 | 66.02 | −11.06 | L13 |
| S15 | 8.10 | 0.61 | | | | |
| S16\grave{ } | ∞ | 0.67 | | | | ST1 |
| S17 | −8.32 | 3.19 | 1.99 | 16.48 | −4.03 | L14 |
| S18 | 9.24 | 2.72 | 1.88 | 40.85 | 5.18 | L15 |
| S19 | −7.88 | 0.08 | | | | |
| S110 | 13.24 | 6.07 | 2.00 | 29.13 | 11.21 | L16 |
| S111 | −59.08 | 6.04 | | | | |
| S112 | ∞ | 0.21 | 1.52 | 64.17 | | OF1 |
| S113 | ∞ | 0.66 | | | | |
| S114 | ∞ | 0.40 | 1.52 | 64.17 | | CG1 |
| S115 | ∞ | 0.13 | | | | |

Table 2 shows the parameters and condition values for conditions (1)-(15) in accordance with the first embodiment of the invention. It can be seen from Table 2 that the lens assembly 1 of the first embodiment satisfies the conditions (1)-(15).

TABLE 2

| θ | 29 degrees | f23 | 14.80 mm | T4 | 3.19 mm |
|---|---|---|---|---|---|
| T5 | 2.72 mm | T6 | 6.07 mm | BFL | 7.43 mm |
| d56 | 0.08 mm | | | | |
| (3.304-f × tan(θ)) × TTL/(f × tan(θ)) | | | | −2.87 | |
| (Vd1 + Vd2)/\|Vd1 − Vd2\| | | 2.05 | (Vd2 + Vd3)/\|Vd2 − Vd3\| | | 2.05 |
| (Vd4 + Vd5)/\|Vd4 − Vd5\| | | 2.35 | f5/f | | 0.77 |
| f6/f | 1.67 | T4/Nd4 | 1.61 mm | BFL/Nd6 | 3.71 mm |
| BFL/f | 1.11 | T4 + T5 + T6 | 11.98 mm | (R11 − R12)/TTL | 0.29 |
| R42/T4 | 2.89 | TTL/d56 | 317.84 | FOV/f | 8.66 degrees/mm |

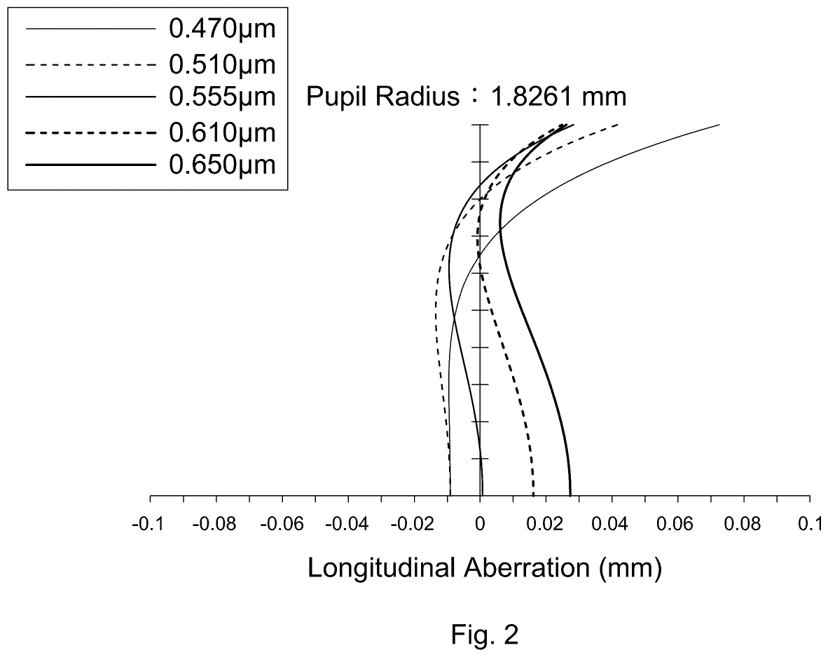

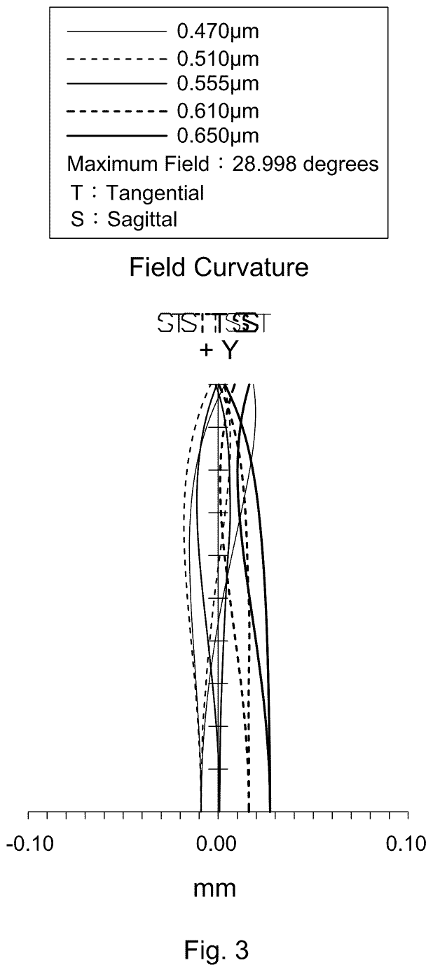

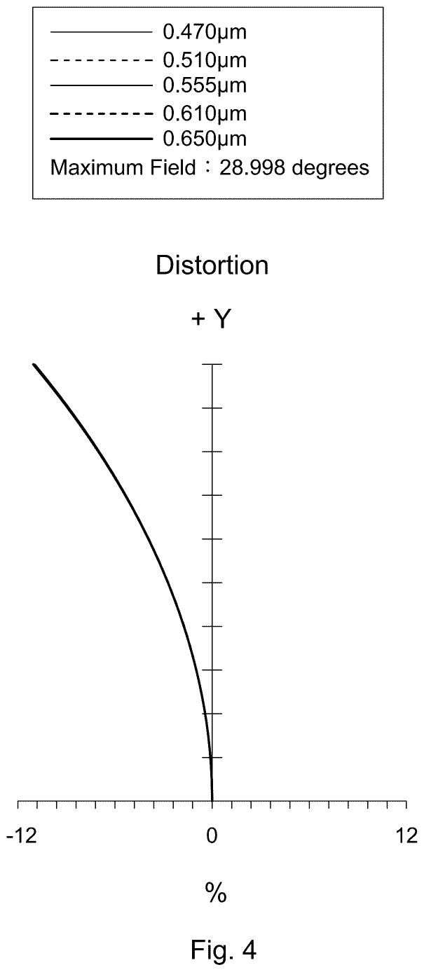

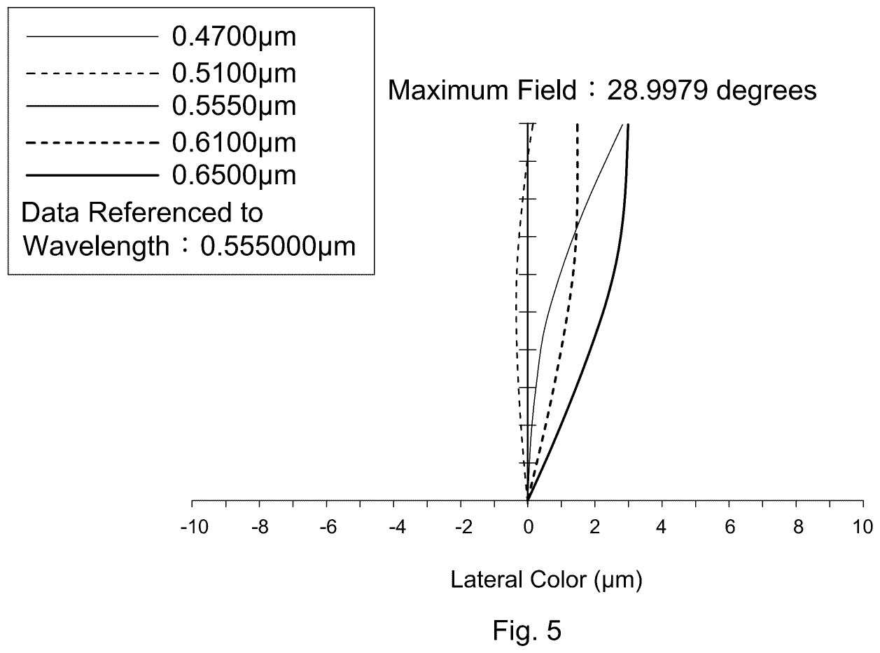

In addition, the lens assembly 1 of the first embodiment can meet the requirements of optical performance. It can be seen from FIG. 2 that the longitudinal aberration in the lens assembly 1 of the first embodiment ranges from −0.02 mm to 0.08 mm. It can be seen from FIG. 3 that the field curvature of tangential direction and sagittal direction in the lens assembly 1 of the first embodiment ranges from −0.02 mm to 0.03 mm. It can be seen from FIG. 4 that the distortion in the lens assembly 1 of the first embodiment ranges from −12% to 0%. It can be seen from FIG. 5 that the lateral color in the lens assembly 1 of the first embodiment ranges from −1 μm to 3 μm. It is obvious that the longitudinal aberration, the field curvature, the distortion, and the lateral color can be corrected effectively for the lens assembly 1 of the first embodiment. Therefore, the lens assembly 1 of the first embodiment is capable of good optical performance.

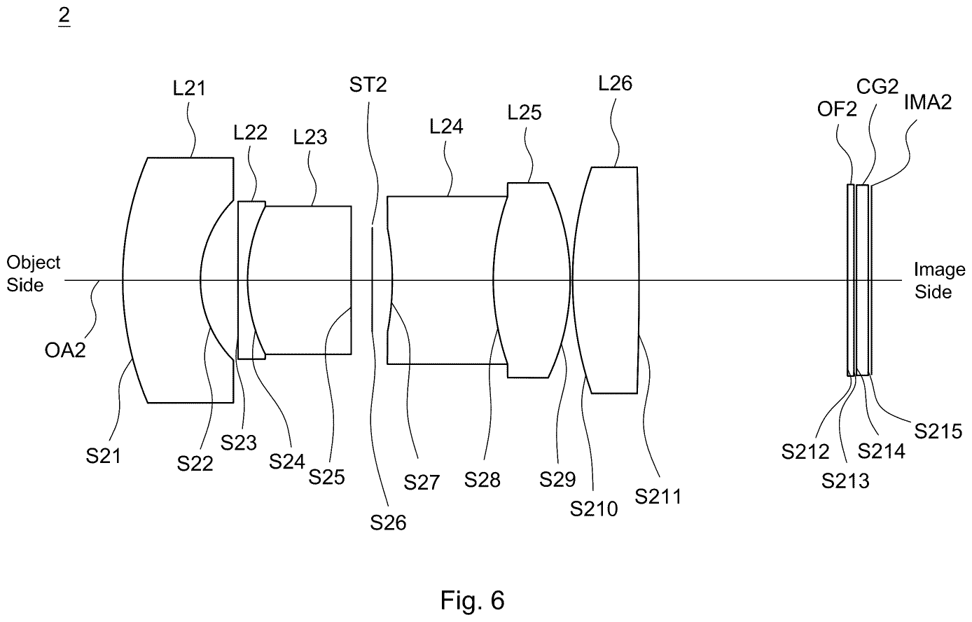

A detailed description of a lens assembly in accordance with a second embodiment of the invention is as follows. Referring to FIG. 6, the lens assembly 2 includes a first lens L21, a second lens L22, a third lens L23, a stop ST2, a fourth lens L24, a fifth lens L25, a sixth lens L26, an optical filter OF2, and a cover glass CG2, all of which are arranged in order from an object side to an image side along an optical axis OA2. In operation, the light from the object side is imaged on an image plane IMA2.

According to the foregoing, wherein: the second lens L22 is a meniscus lens with negative refractive power, wherein the image side surface S24 is a concave surface; the third lens L23 is a meniscus lens with positive refractive power, wherein the object side surface S24 is a convex surface and the image side surface S25 is a concave surface; the second lens L22 and the third lens L23 are cemented or there is no air gap between the second lens L22 and the third lens L23; both of the object side surface S212 and image side surface S213 of the optical filter OF2 are plane surfaces; both of the object side surface S214 and image side surface S215 of the cover glass CG2 are plane surfaces; with the above design of the lenses, stop ST2, and at least one of the conditions (1)-(15) are satisfied, the lens assembly 2 can have an effective decreased total lens length, an effective increased field of view, an effective decreased F-umber, an effective increased resolution, and an effective corrected aberration. The lens assembly 2 of the present invention can meet basic operation requirements when the lens assembly 2 only satisfies conditions (5), (7), or (10); the first lens is with negative refractive power includes a convex surface facing the object side and a concave surface facing the image side; the second lens is with refractive power; the third lens is with refractive power; the fourth lens is with negative refractive power and includes a concave surface facing the image side; the fifth lens is with positive refractive power and includes a convex surface facing the object side; and the sixth lens is with positive refractive power and includes a convex surface facing the object side.

Table 3 shows the optical specification of the lens assembly 2 in FIG. 6.

TABLE 3
Effective Focal Length = 6.69 mm F-number = 1.86
Total Lens Length = 26.09 mm Full Field of View = 58.00 degrees

| | Radius of | | | | Effective | |
|---|---|---|---|---|---|---|
| Surface | Curvature | Thickness | | | Focal | |
| Number | (mm) | (mm) | Nd | Vd | Length (mm) | Remark |
| S21 | 10.95 | 2.71 | 1.61 | 44.29 | −11.97 | L21 |
| S22 | 3.99 | 1.30 | | | | |
| S23 | 163.66 | 0.36 | 1.52 | 64.17 | −11.83 | L22 |
| S24 | 5.91 | 3.58 | 2.05 | 26.99 | 5.77 | L23 |
| S25 | 125.11 | 0.75 | | | | |
| S26 | ∞ | 0.71 | | | 10.63 | ST2 |
| S27 | −9.91 | 3.51 | 1.99 | 16.48 | −4.30 | L24 |
| S28 | 8.90 | 2.68 | 1.83 | 42.72 | 5.42 | L25 |
| S29 | −8.01 | 0.08 | | | | |
| S210 | 12.28 | 2.31 | 2.05 | 26.94 | 10.63 | L26 |
| S211 | −120.78 | 6.70 | | | | |
| S212 | ∞ | 0.21 | 1.52 | 64.17 | | OF2 |
| S213 | ∞ | 0.66 | | | | |
| S214 | ∞ | 0.40 | 1.52 | 64.17 | | CG2 |
| S215 | ∞ | 0.13 | | | | |

Table 4 shows the parameters and condition values for conditions (1)-(15) in accordance with the second embodiment of the invention. It can be seen from Table 4 that the lens assembly 2 of the second embodiment satisfies the conditions (1)-(15).

TABLE 4

| θ | 29 degrees | f23 | 11.44 mm | T4 | 3.51 mm |
|---|---|---|---|---|---|
| T5 | 2.68 mm | T6 | 2.31 mm | BFL | 8.10 mm |
| d56 | 0.08 mm | | | | |
| (3.304-f × tan(θ)) × TTL/(f × tan(θ)) | | | | −2.86 | |
| (Vd1 + Vd2)/\|Vd1 − Vd2\| | | 5.46 | (Vd2 + Vd3)/\|Vd2 − Vd3\| | | 2.45 |
| (Vd4 + Vd5)/\|Vd4 − Vd5\| | | 2.26 | f5/f | | 0.81 |
| f6/f | 1.59 | T4/Nd4 | 1.77 mm | BFL/Nd6 | 3.95 mm |
| BFL/f | 1.21 | T4 + T5 + T6 | 8.50 mm | (R11 − R12)/TTL | 0.27 |
| R42/T4 | 2.54 | TTL/d56 | 310.60 | FOV/f | 8.66 degrees/mm |

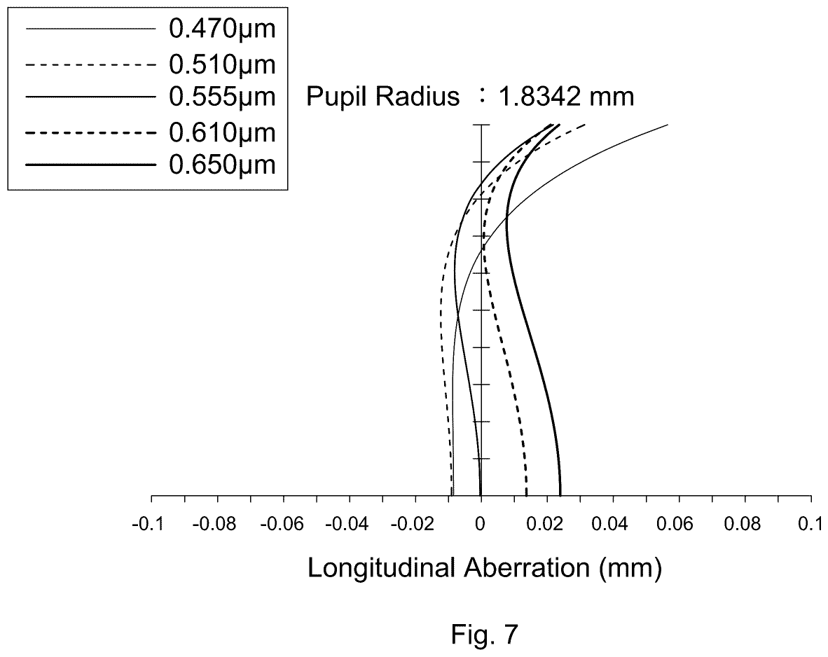

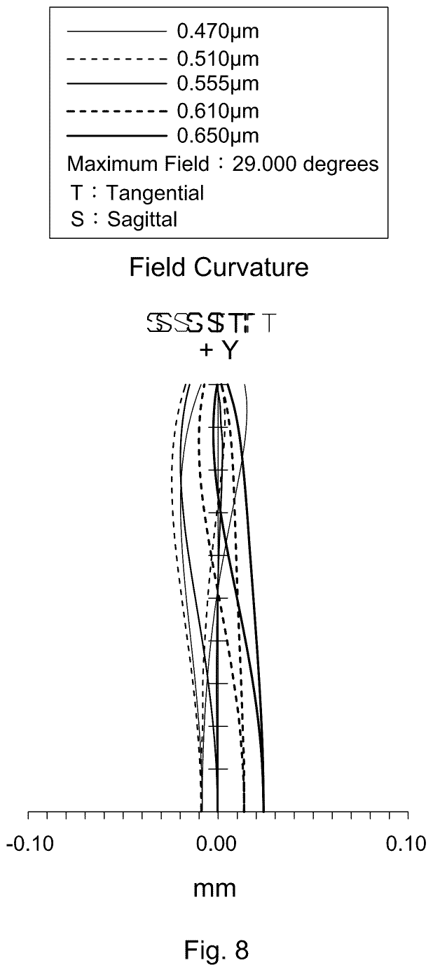

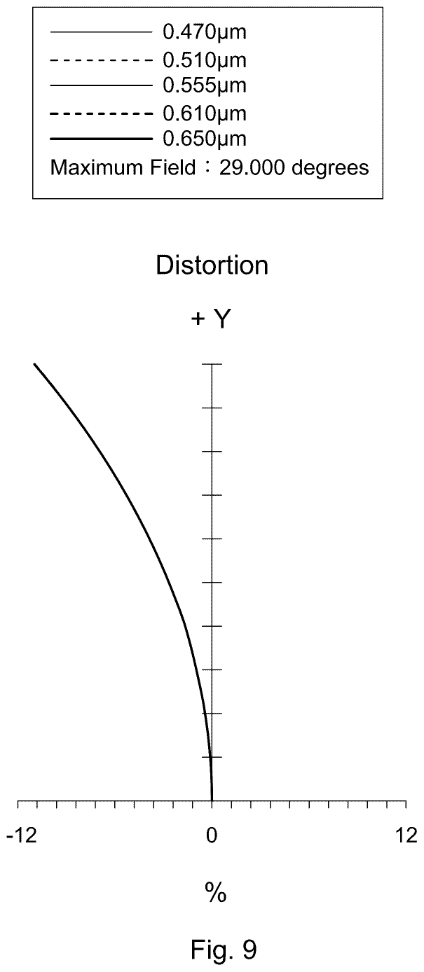

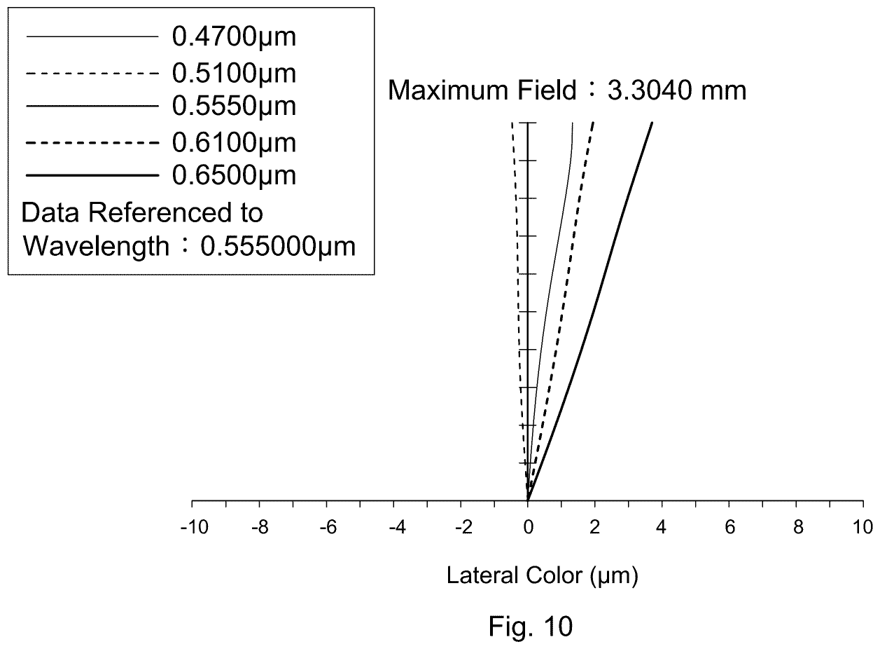

In addition, the lens assembly 2 of the second embodiment can meet the requirements of optical performance. It can be seen from FIG. 7 that the longitudinal aberration in the lens assembly 2 of the second embodiment ranges from −0.02 mm to 0.06 mm. It can be seen from FIG. 8 that the field curvature of tangential direction and sagittal direction in the lens assembly 2 of the second embodiment ranges from −0.03 mm to 0.03 mm. It can be seen from FIG. 9 that the distortion in the lens assembly 2 of the second embodiment ranges from −12% to 0%. It can be seen from FIG. 10 that the lateral color in the lens assembly 2 of the second embodiment ranges from −1 μm to 4 μm. It is obvious that the longitudinal aberration, the field curvature, the distortion, and the lateral color can be corrected effectively for the lens assembly 2 of the second embodiment. Therefore, the lens assembly 2 of the second embodiment is capable of good optical performance.

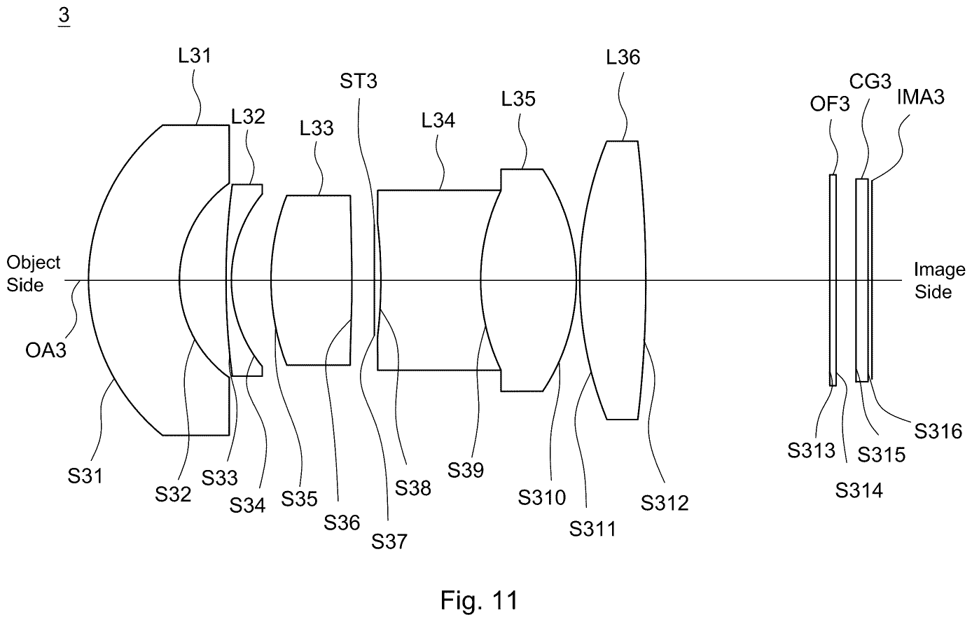

A detailed description of a lens assembly in accordance with a third embodiment of the invention is as follows. Referring to FIG. 11, the lens assembly 3 includes a first lens L31, a second lens L32, a third lens L33, a stop ST3, a fourth lens L34, a fifth lens L35, a sixth lens L36, an optical filter OF3, and a cover glass CG3, all of which are arranged in order from an object side to an image side along an optical axis OA3. In operation, the light from the object side is imaged on an image plane IMA3.

According to the foregoing, wherein: the second lens 32 is a meniscus lens with negative refractive power, wherein the image side surface S34 is a concave surface; the third lens L33 is a biconvex lens with positive refractive power, wherein the object side surface S35 is a convex surface and the image side surface S36 is a convex surface; both of the object side surface S313 and image side surface S314 of the optical filter OF3 are plane surfaces; both of the object side surface S315 and image side surface S316 of the cover glass CG3 are plane surfaces; with the above design of the lenses, stop ST3, and at least one of the conditions (1)-(15) are satisfied, the lens assembly 3 can have an effective decreased total lens length, an effective increased field of view, an effective decreased F-umber, an effective increased resolution, and an effective corrected aberration. The lens assembly 3 of the present invention can meet basic operation requirements when the lens assembly 3 only satisfies conditions (12) or (13); the first lens is with negative refractive power and includes a convex surface facing the object side and a concave surface facing the image side; the second lens is with refractive power; the third lens is with refractive power; the fourth lens is with negative refractive power and includes a concave surface facing the image side; the fifth lens is with positive refractive power and includes a convex surface facing the object side; and the sixth lens is with positive refractive power and includes a convex surface facing the object side.

Table 5 shows the optical specification of the lens assembly 3 in FIG. 11.

TABLE 5
Effective Focal Length = 6.70 mm F-number = 1.85
Total Lens Length = 25.93 mm Full Field of View = 57.36 degrees

| | Radius of | | | | Effective | |
|---|---|---|---|---|---|---|
| Surface | Curvature | Thickness | | | Focal | |
| Number | (mm) | (mm) | Nd | Vd | Length (mm) | Remark |
| S31 | 6.60 | 3.02 | 2.10 | 17.02 | −22.94 | L31 |
| S32 | 3.98 | 1.56 | | | | |
| S33 | 26.52 | 0.17 | 1.59 | 60.47 | −9.15 | L32 |
| S34 | 4.51 | 1.31 | | | | |
| S35 | 7.91 | 2.68 | 2.05 | 26.94 | 6.52 | L33 |
| S36 | −44.33 | 0.74 | | | | |
| S37 | ∞ | 0.21 | | | | ST3 |
| S38 | −16.59 | 3.30 | 1.96 | 17.47 | −4.74 | L34 |
| S39 | 6.97 | 3.19 | 1.59 | 68.34 | 6.22 | L35 |
| S310 | −6.53 | 0.09 | | | | |
| S311 | 12.32 | 2.20 | 2.00 | 29.13 | 9.47 | L36 |
| S312 | −38.44 | 6.08 | | | | |
| S313 | ∞ | 0.21 | 1.52 | 64.17 | | OF3 |
| S314 | ∞ | 0.66 | | | | |
| S315 | ∞ | 0.40 | 1.52 | 64.17 | | CG3 |
| S316 | ∞ | 0.13 | | | | |

Table 6 shows the parameters and condition values for conditions (1)-(15) in accordance with the third embodiment of the invention. It can be seen from Table 6 that the lens assembly 3 of the third embodiment satisfies the conditions (1)-(15).

TABLE 6

| | | | | | | |
|---|---|---|---|---|---|---|
| θ | 28.68 | degrees | f23 | 14.47 mm | T4 | 3.30 mm |
| T5 | 3.19 | mm | T6 | 2.20 mm | BFL | 7.47 mm |
| d56 | 0.09 | mm | | | | |

| (3.304-f × tan(θ)) × TTL/(f × tan(θ)) | | | | −2.56 | |
|---|---|---|---|---|---|
| (Vd1 + Vd2)/\|Vd1 − Vd2\| | | 1.78 | (Vd2 + Vd3)/\|Vd2 − Vd3\| | | 2.61 |
| (Vd4 + Vd5)/\|Vd4 − Vd5\| | | 1.69 | f5/f | | 0.93 |
| f6/f | 1.41 | T4/Nd4 | 1.69 mm | BFL/Nd6 | 3.73 mm |
| BFL/f | 1.11 | T4 + T5 + T6 | 8.69 mm | (R11 − R12)/TTL | 0.10 |
| R42/T4 | 2.11 | TTL/d56 | 305.11 | FOV/f | 8.56 degrees/mm |

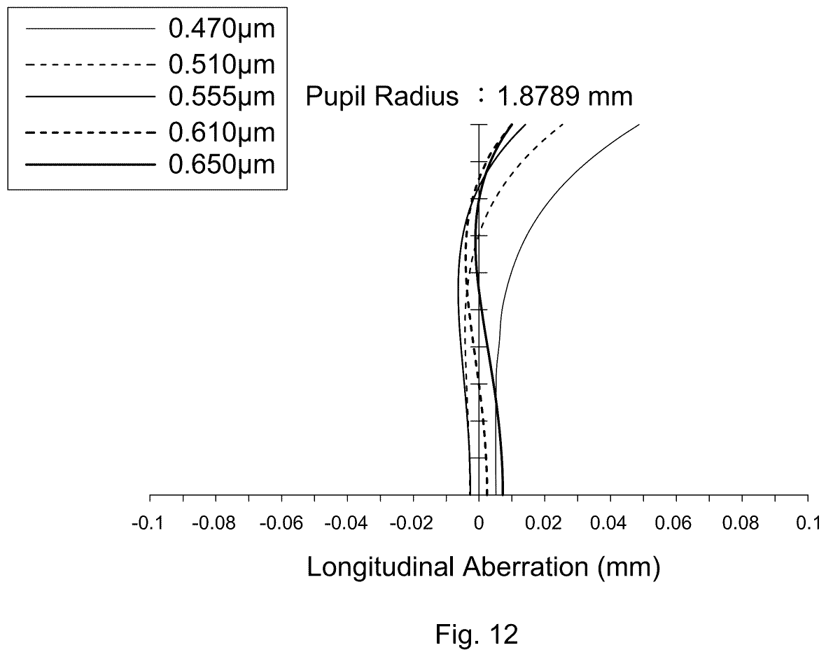

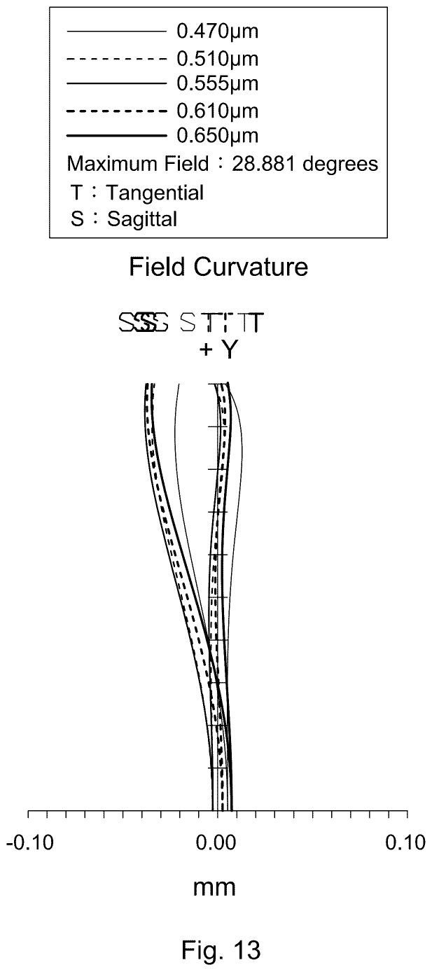

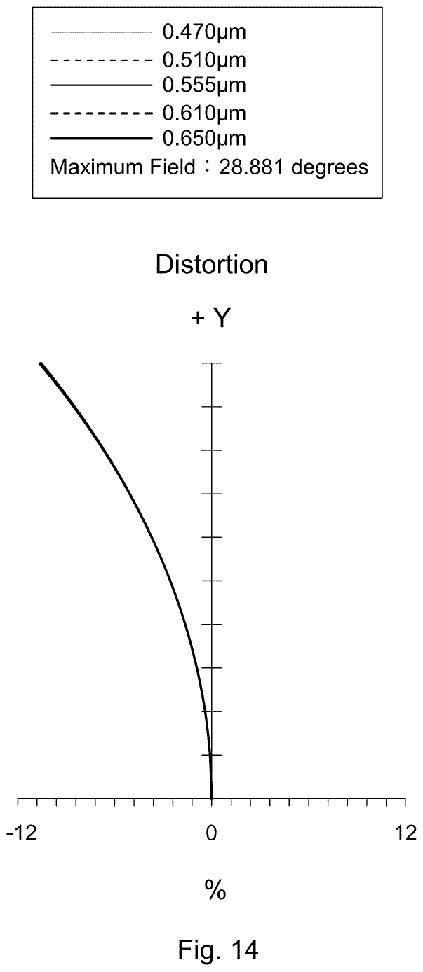

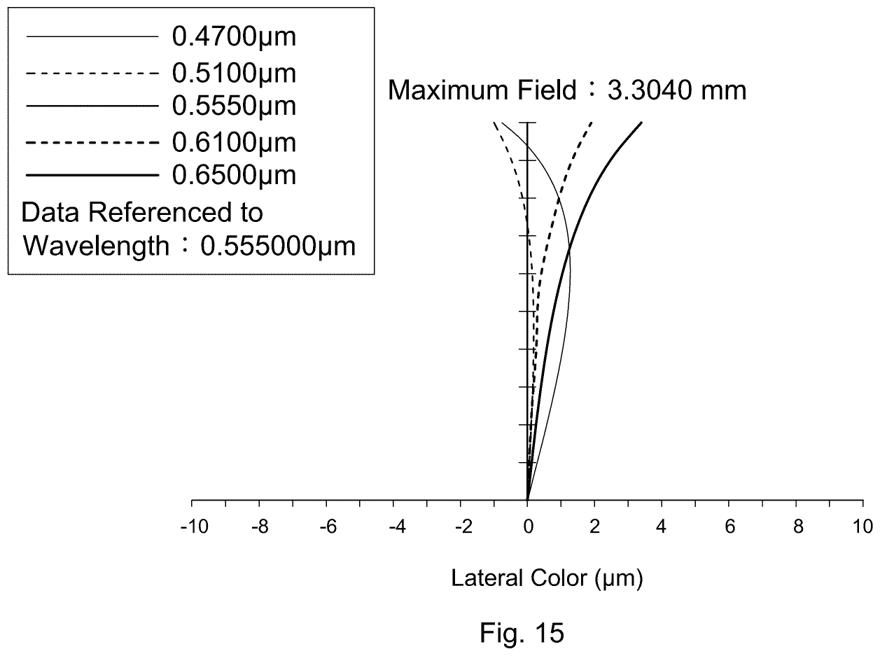

In addition, the lens assembly 3 of the third embodiment can meet the requirements of optical performance. It can be seen from FIG. 12 that the longitudinal aberration in the lens assembly 3 of the third embodiment ranges from −0.01 mm to 0.05 mm. It can be seen from FIG. 13 that the field curvature of tangential direction and sagittal direction in the lens assembly 3 of the third embodiment ranges from −0.04 mm to 0.01 mm. It can be seen from FIG. 14 that the distortion in the lens assembly 3 of the third embodiment ranges from −11% to 0%. It can be seen from FIG. 15 that the lateral color in the lens assembly 3 of the third embodiment ranges from −1 μm to 4 μm. It is obvious that the longitudinal aberration, the field curvature, the distortion, and the lateral color can be corrected effectively for the lens assembly 3 of the third embodiment. Therefore, the lens assembly 3 of the third embodiment is capable of good optical performance.

Referring to Table 7, Table 9, Table 11, Table 13, and Table 15, wherein Table 7, Table 9, Table 11, Table 13, and Table 15 show optical specification in accordance with a fourth, a fifth, a sixth, a seventh, and an eighth embodiments of the invention, respectively.

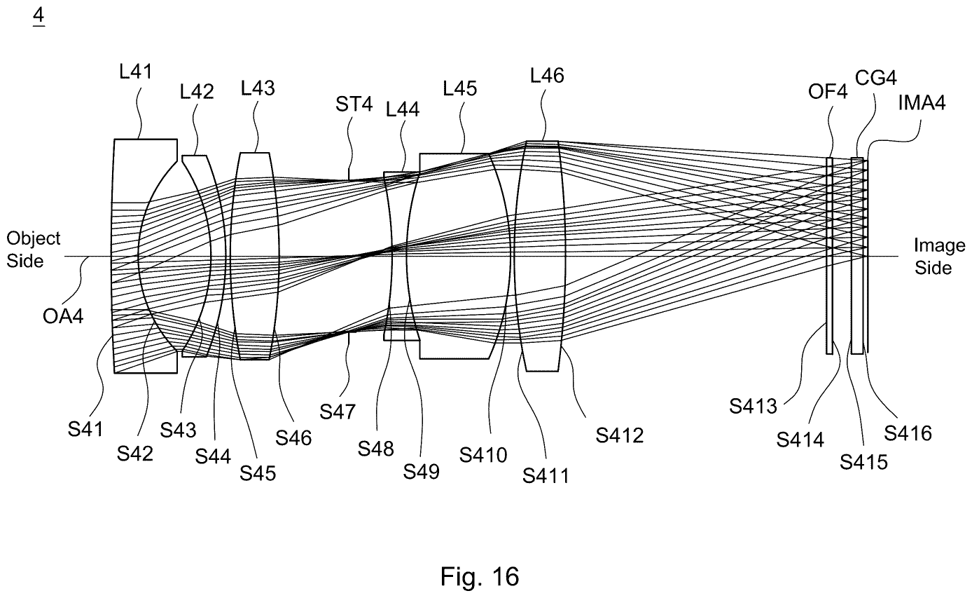

FIGS. 16, 21, 22, 23, and 28 are lens layout and optical path diagrams of the lens assemblies in accordance with the fourth, fifth, sixth, seventh, and eighth embodiments of the invention, respectively.

The first lenses L41, L51, L61, L71, L81 are meniscus lenses with negative refractive power and made of glass material, wherein the object side surfaces S41, S51, S61, S71, S81 are convex surfaces, the image side surfaces S42, S52, S62, S72, S82 are concave surfaces, and both of the object side surfaces S41, S51, S61, S71, S81 and image side surfaces S42, S52, S62, S72, S82 are spherical surfaces.

The second lenses L42, L52, L62, L72, L82 are with refractive power and made of glass material, wherein both of the object side surfaces S43, S53, S63, S73, S83 and image side surfaces S44, S54, S64, S74, S84 are spherical surfaces.

The third lenses L43, L53, L63, L73, L83 are with positive refractive power and made of glass material, wherein the object side surfaces S45, S55, S65, S75, S85 are convex surfaces and both of the object side surfaces S45, S55, S65, S75, S85 and image side surfaces S46, S56, S66, S76, S86 are spherical surfaces.

The fourth lenses L44, L54, L64, L74, L84 are biconcave lenses with negative refractive power and made of glass material, wherein the object side surfaces S48, S58, S68, S78, S88 are concave surfaces, the image side surfaces S49, S59, S69, S79, S89 are concave surfaces, and both of the object side surfaces S48, S58, S68, S78, S88 and image side surfaces S49, S59, S69, S79, S89 are spherical surfaces.

The fifth lenses L45, L55, L65, L75, L85 are biconvex lenses with positive refractive power and made of glass material, wherein the object side surfaces S49, S59, S69, S79, S89 are convex surfaces, the image side surfaces S410, S510, S610, S710, S810 are convex surfaces, and both of the object side surfaces S49, S59, S69, S79, S89 and image side surfaces S410, S510, S610, S710, S810 are spherical surfaces.

The fourth lenses L44, L54, L64, L74, L84 and the fifth lenses L45, L55, L65, L75, L85 are cemented or there is no air gap between the fourth lenses L44, L54, L64, L74, L84 and the fifth lenses L45, L55, L65, L75, L85, respectively.

The sixth lenses L46, L56, L66, L76, L86 are biconvex lenses with positive refractive power and made of glass material, wherein the object side surfaces S411, S511, S611, S711, S811 are convex surfaces, the image side surfaces S412, S512, S612, S712, S812 are convex surfaces, and both of the object side surfaces S411, S511, S611, S711, S811 and image side surfaces S412, S512, S612, S712, S812 are spherical surfaces.

In addition, the lens assemblies 4, 5, 6, 7 and 8 satisfy at least one of the following conditions (16)-(25):

$$- 16 mm < ( R 11 / R 41 ) \times T 5 < - 1 mm ; \qquad ( 16 )$$

$$12 mm < {( R 21 \times R 62 )}^{0.5} < 141 mm ; \qquad ( 17 )$$

$$5 {mm}^{- 1} < Vd 1 / T 1 < 118 {mm}^{- 1} ; \qquad ( 18 )$$

$$10 < {( \vert f 6 \times R 62 \vert )}^{0.5} / ( T 3 ) < 32 ; \qquad ( 19 )$$

$$- 13 < ( R 11 + R 22 ) / T 1 < 80 ; \qquad ( 20 )$$

$$41 mm < f 5 / ( T 4 / T 3 ) < 120 mm ; \qquad ( 21 )$$

$$28 mm < ( d 12 / T 2 ) \times R 42 < 53 mm ; \qquad ( 22 )$$

$$25 mm < ( R 11 - R 62 ) / Nd 2 < 88 mm ; \qquad ( 23 )$$

$$- 45 {mm}^{2} < ( f 2 + f 5 ) \times T 3 < 135 {mm}^{2} ; \qquad ( 24 )$$

$$19 mm < ( R 41 \times R 62 ) 0.5 < 39 mm ; \qquad ( 25 )$$

wherein the parameters in the fourth to eighth embodiments are defined as follows: T1 is an interval from the object side surfaces S41, S51, S61, S71, S81 of the first lenses L41, L51, L61, L71, L81 to the image side surfaces S42, S52, S62, S72, S82 of the first lenses L41, L51, L61, L71, L81 along the optical axes OA4, OA5, OA6, OA7, OA8; T2 is an interval from the object side surfaces S43, S53, S63, S73, S83 of the second lenses L42, L52, L62, L72, L82 to the image side surfaces S44, S54, 570 S64, S74, S84 of the second lenses L42, L52, L62, L72, L82 along the optical axes OA4, OA5, OA6, OA7, OA8; T3 is an interval from the object side surfaces S45, S55, S65, S75, S85 of the third lenses L43, L53, L63, L73, L83 to the image side surfaces S46, S56, S66, S76, S86 of the third lenses L43, L53, L63, L73, L83 along the optical axes OA4, OA5, OA6, OA7, OA8; T4 is an interval from the object side surfaces S48, 575 S58, S68, S78, S88 of the fourth lenses L44, L54, L64, L74, L84 to the image side surfaces S49, S59, S69, S79, S89 of the fourth lenses L44, L54, L64, L74, L84 along the optical axes OA4, OA5, OA6, OA7, OA8; T5 is an interval from the object side surfaces S49, S59, S69, S79, S89 of the fifth lenses L45, L55, L65, L75, L85 to the image side surfaces S410, S510, S610, S710, S810 of the fifth lenses L45, L55, L65, 580 L75, L85 along the optical axes OA4, OA5, OA6, OA7, OA8; R11 is a radius of curvature of the object side surfaces S41, S51, S61, S71, S81 of the first lenses L41, L51, L61, L71, L81; R21 is a radius of curvature of the object side surfaces S43, S53, S63, S73, S83 of the second lenses L42, L52, L62, L72, L82; R22 is a radius of curvature of the image side surfaces S44, S54, S64, S74, S84 of the second lenses L42, 585 L52, L62, L72, L82; R41 is a radius of curvature of the object side surfaces S48, S58, S68, S78, S88 of the fourth lenses L44, L54, L64, L74, L84; R42 is a radius of curvature of the image side surfaces S49, S59, S69, S79, S89 of the fourth lenses L44, L54, L64, L74, L84; R62 is a radius of curvature of the image side surfaces S412, S512, S612, S712, S812 of the sixth lenses L46, L56, L66, L76, L86; f2 is an effective focal length of the second lenses L42, L52, L62, L72, L82; f5 is an effective focal length of the fifth lenses L45, L55, L65, L75, L85; f6 is an effective focal length of the sixth lenses L46, L56, L66, L76, L86; d12 is an air interval from the image side surfaces S42, S52, S62, S72, S82 of the first lenses L41, L51, L61, L71, L81 to the object side surfaces S43, S53, S63, S73, S83 of the second lenses L42, L52, L62, L72, L82 along the optical axes OA4, OA5, OA6, OA7, OA8; Vd1 is an Abbe number of the first lenses L41, L51, L61, L71, L81; and Nd2 is a refractive index of the second lenses L42, L52, L62, L72, L82. Making the lens assemblies 4, 5, 6, 7, and 8 decreasing the total lens length effectively, decreasing the F-number effectively, resisting the environment temperature effectively, and correcting the aberration effectively.

When the condition (16): −16 mm<(R11/R41)×T5<−1 mm is satisfied, the aberration can be effectively corrected and the resolution can be effectively increased. When the condition (17): 12 mm<(R21×R62)^{0.5}<141 mm is satisfied, the aberration can be effectively corrected and the resolution can be effectively increased. When the condition (18): 5 mm⁻¹<Vd1/T1<118 mm⁻¹ is satisfied, the aberration can be effectively corrected and the resolution can be effectively increased. When the condition (19): 10<(|f6×R62|)^{0.5}/(T3)<32 is satisfied, the effective focal length of the sixth lens, the radius of curvature of the image side surface of the sixth lens, and the thickness of the third lens can be effectively controlled to correct aberration. When the condition (20): −13<(R11+R22)/T1<80 is satisfied, the radius of curvature of the object side surface of the first lens, the radius of curvature of the image side surface of the second lens, and the thickness of the first lens can be effectively controlled to correct off-axis aberration. When the condition (21): 41 mm<f5/(T4/T3)<120 mm is satisfied, the effective focal length of the fifth length, the thickness of the fourth lens, and the thickness of the third lens can be effectively controlled to correct off-axis aberration. When the condition (22): 28 mm<(d12/T2)×R42<53 mm is satisfied, the air gap between the first lens and the second lens, the thickness of the second lens, and the radius of curvature of the image side surface of the fourth lens can be effectively controlled to correct off-axis aberration. When the condition (23): 25 mm<(R11−R62)/Nd2<88 mm is satisfied, the chromatic aberration can be effectively corrected and the resolution can be effectively increased. When the condition (24): −45 mm²<(f2+f5)×T3<135 mm² is satisfied, the aberration can be effectively corrected and the resolution can be effectively increased. When the condition (25): 19 mm<(R41×R62)^{0.5}<39 mm is satisfied, the aberration can be effectively corrected and the resolution can be effectively increased.

A detailed description of a lens assembly in accordance with a fourth embodiment of the invention is as follows. Referring to FIG. 16, the lens assembly 4 includes a first lens L41, a second lens L42, a third lens L43, a stop ST4, a fourth lens L44, a fifth lens L45, a sixth lens L46, an optical filter OF4, and a cover glass CG4, all of which are arranged in order from an object side to an image side along an optical axis OA4. The combined effective focal length of the combination of the second lens L42 and the third lens L43 is equal to 9.68 mm. In operation, the light from the object side is imaged on an image plane IMA4.

According to the foregoing, wherein: the second lens L42 is a meniscus lens with negative refractive power, wherein the object side surface S43 is a concave surface, the image side surface S44 is a convex surface; the third lens L43 is a biconvex lens, wherein the image side surface S46 is a convex surface; both of the object side surface S413 and image side surface S414 of the optical filter OF4 are plane surfaces; both of the object side surface S415 and image side surface S416 of the cover glass CG4 are plane surfaces; with the above design of the lenses, stop ST4, and at least one of the conditions (16)-(25) are satisfied, the lens assembly 4 can have an effective decreased total lens length, an effective decreased F-umber, an effective resisted environment temperature, and an effective corrected aberration. The lens assembly 4 of the present invention can meet basic operation requirements when the lens assembly 4 only satisfies conditions (4) or (10); the first lens is with negative refractive power and includes a convex surface facing the object side and a concave surface facing the image side; the second lens is with refractive power; the third lens is with refractive power and includes a convex surface facing the object side; the fourth lens is with refractive power and includes a concave surface facing the object side; the fifth lens is with refractive power and includes a convex surface facing the image side; and the sixth lens is with refractive power.

Table 7 shows the optical specification of the lens assembly 4 in FIG. 16.

TABLE 7
Effective Focal Length = 6.70 mm F-number = 1.85
Total Lens Length = 26.06 mm Full Field of View = 57.90 degrees

| | Radius of | | | | Effective | |
|---|---|---|---|---|---|---|
| Surface | Curvature | Thickness | | | Focal | |
| Number | (mm) | (mm) | Nd | Vd | Length (mm) | Remark |
| S41 | 59.12 | 0.87 | 1.59 | 61.25 | −8.39 | L41 |
| S42 | 4.55 | 2.60 | | | | |
| S43 | −5.80 | 0.51 | 1.50 | 64.78 | −38.50 | L42 |
| S44 | −8.50 | 0.10 | | | | |
| S45 | 16.62 | 1.73 | 2.05 | 26.99 | 8.07 | L43 |
| S46 | −16.62 | 2.37 | | | | |
| S47 | ∞ | 1.52 | | | | ST4 |
| S48 | −13.90 | 0.46 | 1.96 | 17.47 | −8.86 | L44 |
| S49 | 8.22 | 3.63 | 1.62 | 63.41 | 24.93 | L45 |
| S410 | −8.22 | 0.10 | | | | |
| S411 | 17.68 | 1.77 | 2.00 | 29.14 | 10.96 | L46 |
| S412 | −27.96 | 9.01 | | | | |
| S413 | ∞ | 0.21 | 1.52 | 64.17 | | OF4 |
| S414 | ∞ | 0.66 | | | | |
| S415 | ∞ | 0.40 | 1.52 | 64.17 | | CG4 |
| S416 | ∞ | 0.13 | | | | |

Table 8 shows the parameters and condition values for conditions (16)-(25) in accordance with the fourth embodiment of the invention. It can be seen from Table 8 that the lens assembly 4 of the fourth embodiment satisfies the conditions (16)-(25).

TABLE 8

| T1 | 0.87 | mm | T2 | 0.51 | mm | T3 | 1.73 | mm |
|---|---|---|---|---|---|---|---|---|
| T4 | 0.46 | mm | T5 | 3.63 | mm | d12 | 2.60 | mm |
| (R11/R41) × T5 | −15.43 | mm | (R21 × R62)^{0.5} | 12.73 | mm | Vd1/T1 | 70.08 | mm⁻¹ |
| (\|f6 × R62\|)^{0.5}/(T3) | 10.12 | | (R11 + R22)/T1 | 57.92 | | f5/(T4/T3) | 94.11 | mm |
| (d12/T2) × R42 | 41.57 | mm | (R11 − R62)/Nd2 | 57.88 | mm | (f2 + f5) × T3 | −23.46 | mm² |

| | | |
|---|---|---|
| (R41 × R62)^{0.5} | 19.71 | mm |

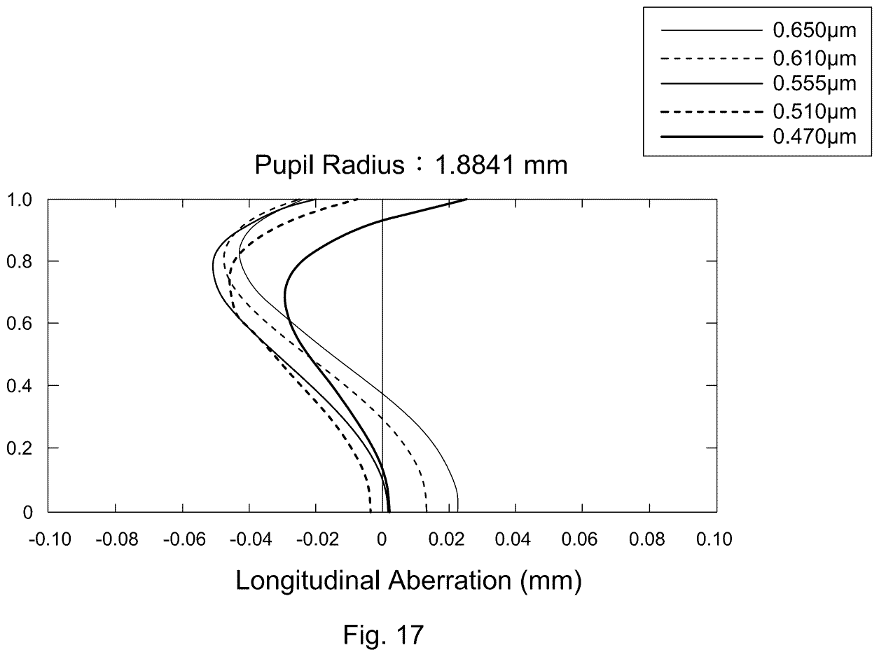

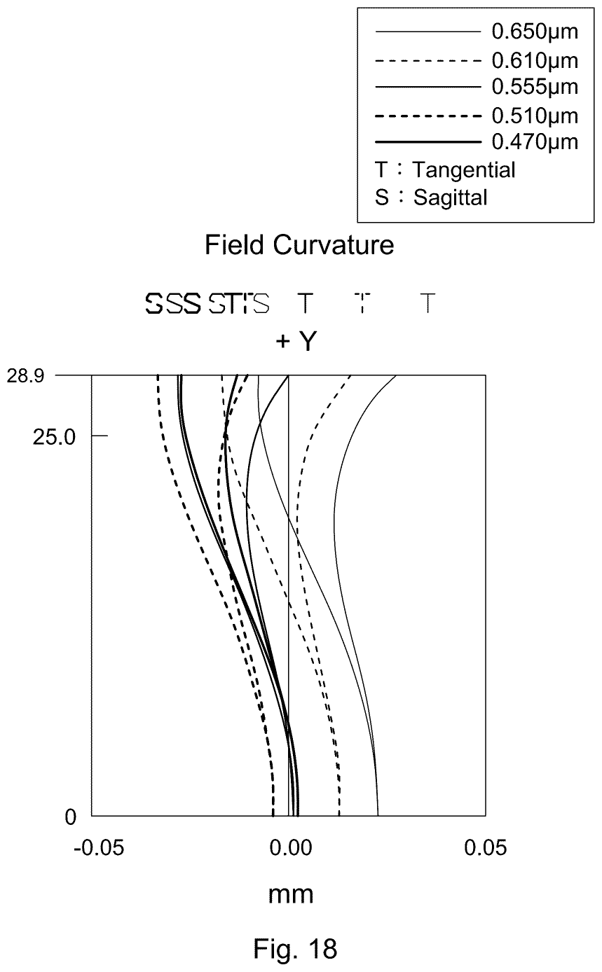

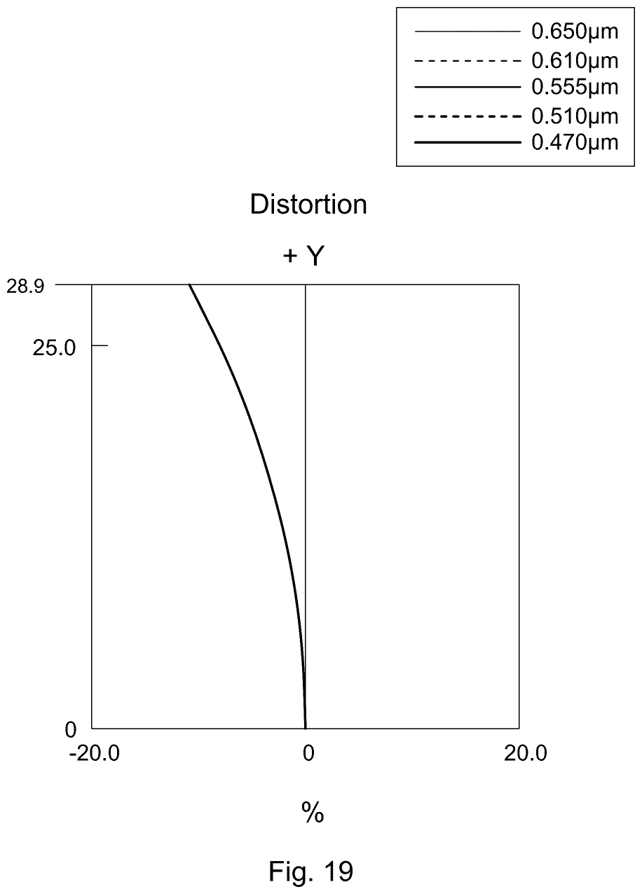

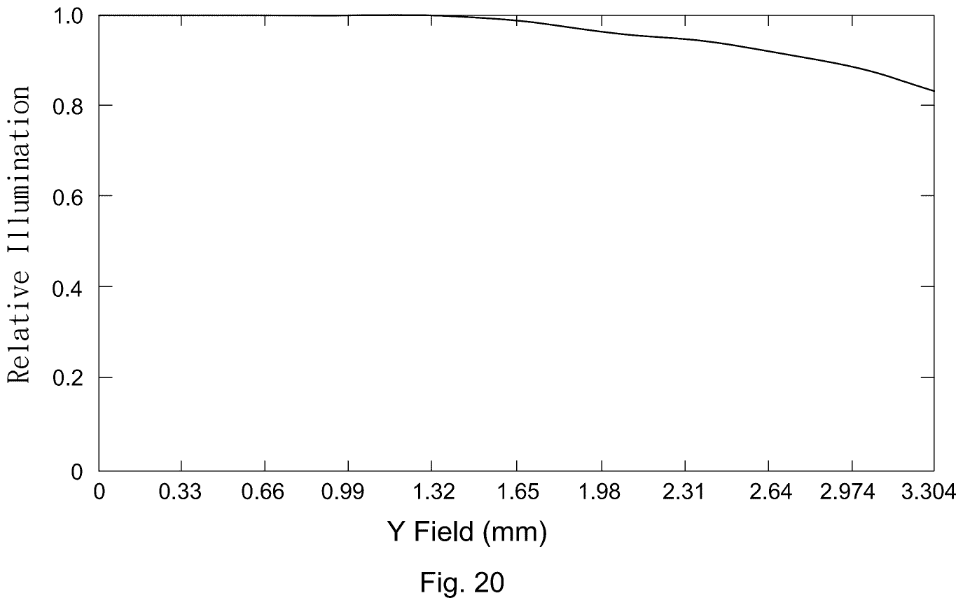

In addition, the lens assembly 4 of the fourth embodiment can meet the requirements of optical performance. It can be seen from FIG. 17 that the longitudinal aberration in the lens assembly 4 of the fourth embodiment ranges from −0.06 mm to 0.03 mm. It can be seen from FIG. 18 that the field curvature of tangential direction and sagittal direction in the lens assembly 4 of the fourth embodiment ranges from −0.04 mm to 0.03 mm. It can be seen from FIG. 19 that the distortion in the lens assembly 4 of the fourth embodiment ranges from −12% to 0%. It can be seen from FIG. 20 that the relative illumination in the lens assembly 4 of the fourth embodiment ranges from 0.83 to 1.0. It is obvious that the longitudinal aberration, the field curvature, and the distortion can be corrected effectively for the lens assembly 4 of the fourth embodiment. Therefore, the lens assembly 4 of the fourth embodiment is capable of good optical performance.

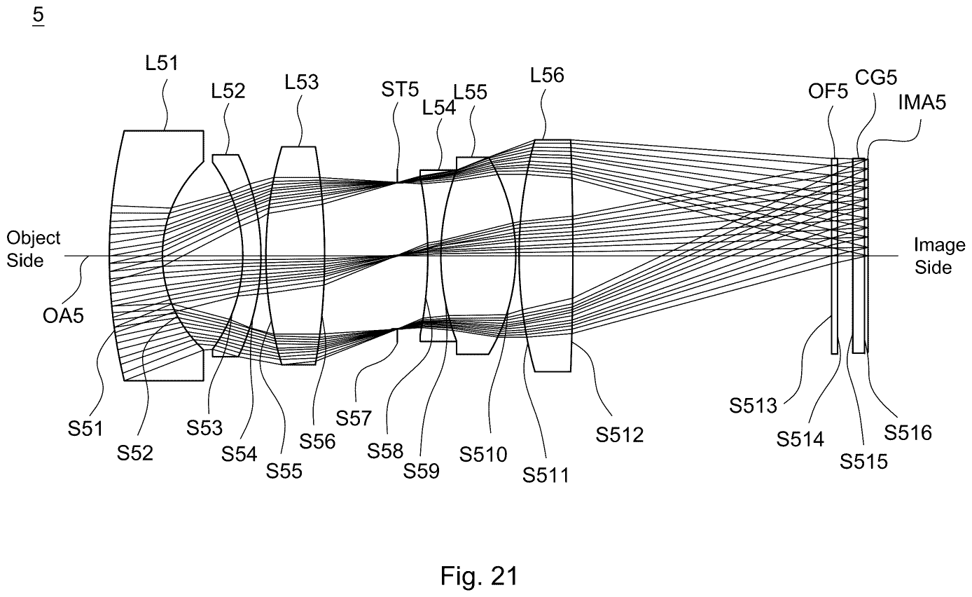

A detailed description of a lens assembly in accordance with a fifth embodiment of the invention is as follows. Referring to FIG. 21, the lens assembly 5 includes a first lens L51, a second lens L52, a third lens L53, a stop ST5, a fourth lens L54, a fifth lens L55, a sixth lens L56, an optical filter OF5, and a cover glass CG5, all of which are arranged in order from an object side to an image side along an optical axis OA5. The combined effective focal length of the combination of the second lens L52 and the third lens L53 is equal to 9.10 mm. In operation, the light from the object side is imaged on an image plane IMA5.

According to the foregoing, wherein: the second lens L52 is a meniscus lens with negative refractive power, wherein the object side surface S53 is a concave surface, the image side surface S54 is a convex surface; the third lens L53 is a biconvex lens, wherein the image side surface S56 is a convex surface; both of the object side surface S513 and image side surface S514 of the optical filter OF5 are plane surfaces; both of the object side surface S515 and image side surface S516 of the cover glass CG5 are plane surfaces; with the above design of the lenses, stop ST5, and at least one of the conditions (16)-(25) are satisfied, the lens assembly 5 can have an effective decreased total lens length, an effective decreased F-umber, an effective resisted environment temperature, and an effective corrected aberration. The lens assembly 5 of the present invention can meet basic operation requirements when the lens assembly 5 only satisfies conditions (4) or (10); the first lens is with negative refractive power and includes a convex surface facing the object side and a concave surface facing the image side; the second lens is with refractive power; the third lens is with refractive power and includes a convex surface facing the object side; the fourth lens is with refractive power and includes a concave surface facing the object side; the fifth lens is with refractive power and includes a convex surface facing the image side; and the sixth lens is with refractive power.

Table 9 shows the optical specification of the lens assembly 5 in FIG. 21.

TABLE 9
Effective Focal Length = 6.66 mm F-number = 1.85
Total Lens Length = 26.08 mm Full Field of View = 57.50 degrees

| | Radius of | | | | Effective | |
|---|---|---|---|---|---|---|
| Surface | Curvature | Thickness | | | Focal | |
| Number | (mm) | (mm) | Nd | Vd | Length (mm) | Remark |
| S51 | 18.64 | 1.76 | 1.76 | 26.52 | −7.63 | L51 |
| S52 | 4.27 | 2.81 | | | | |
| S53 | −5.48 | 0.67 | 1.50 | 66.05 | −41.99 | L52 |
| S54 | −7.71 | 0.10 | | | | |
| S55 | 12.77 | 2.05 | 2.00 | 19.32 | 7.87 | L53 |
| S56 | −19.49 | 2.50 | | | | |
| S57 | ∞ | 1.08 | | | | ST5 |
| S58 | −12.53 | 0.40 | 1.96 | 17.47 | −7.99 | L54 |
| S59 | 7.96 | 2.59 | 1.59 | 68.34 | 20.51 | L55 |
| S510 | −6.68 | 0.10 | | | | |
| S511 | 13.66 | 1.86 | 2.00 | 29.14 | 11.20 | L56 |
| S512 | −60.58 | 8.93 | | | | |
| S513 | ∞ | 0.21 | 1.52 | 64.17 | | OF5 |
| S514 | ∞ | 0.50 | | | | |
| S515 | ∞ | 0.40 | 1.52 | 64.17 | | CG5 |
| S516 | ∞ | 0.13 | | | | |

Table 10 shows the parameters and condition values for conditions (16)-(25) in accordance with the fifth embodiment of the invention. It can be seen from Table 10 that the lens assembly 5 of the fifth embodiment satisfies the conditions (16)-(25).

TABLE 10

| T1 | 1.76 | mm | T2 | 0.67 | mm | T3 | 2.05 | mm |
|---|---|---|---|---|---|---|---|---|
| T4 | 0.40 | mm | T5 | 2.59 | mm | d12 | 2.81 | mm |
| (R11/R41) × T5 | −3.85 | mm | (R21 × R62)^{0.5} | 18.22 | mm | Vd1/T1 | 15.04 | mm⁻¹ |
| (\|f6 × R62\|)^{0.5}/(T3) | 12.70 | | (R11 + R22)/T1 | 6.20 | | f5/(T4/T3) | 104.64 | mm |
| (d12/T2) × R42 | 33.39 | mm | (R11 − R62)/Nd2 | 52.80 | mm | (f2 + f5) × T3 | −44.06 | mm² |

| | | |
|---|---|---|
| (R41 × R62)^{0.5} | 27.54 | mm |

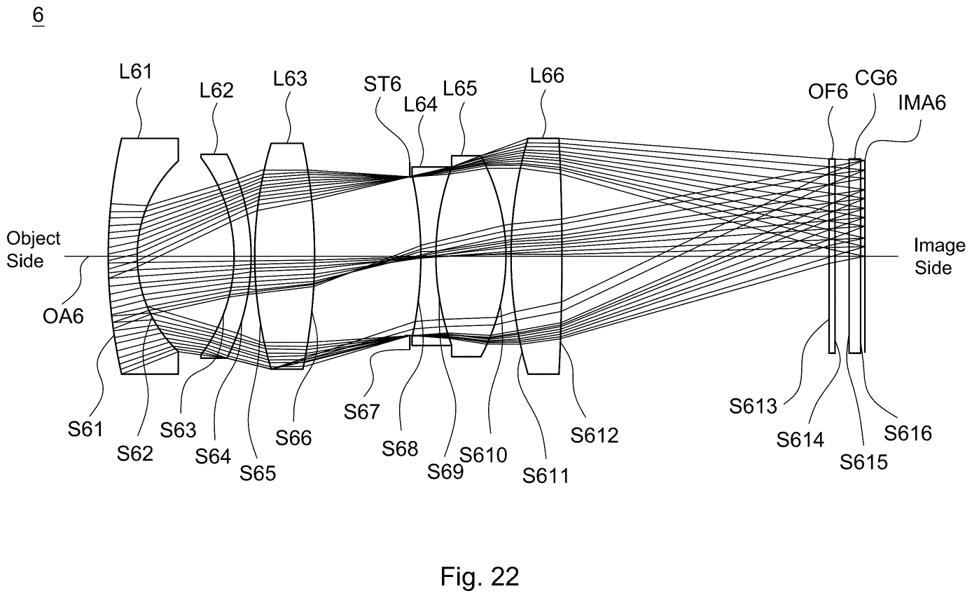

A detailed description of a lens assembly in accordance with a sixth embodiment of the invention is as follows. Referring to FIG. 22, the lens assembly 6 includes a first lens L61, a second lens L62, a third lens L63, a stop ST6, a fourth lens L64, a fifth lens L65, a sixth lens L66, an optical filter OF6, and a cover glass CG6, all of which are arranged in order from an object side to an image side along an optical axis OA6. The combined effective focal length of the combination of the second lens L62 and the third lens L63 is equal to 9.65 mm. In operation, the light from the object side is imaged on an image plane IMA6.

According to the foregoing, wherein: the second lens L62 is a meniscus lens with negative refractive power, wherein the object side surface S63 is a concave surface, the image side surface S64 is a convex surface; the third lens L63 is a biconvex lens, wherein the image side surface S66 is a convex surface; both of the object side surface S613 and image side surface S614 of the optical filter OF6 are plane surfaces; both of the object side surface S615 and image side surface S616 of the cover glass CG6 are plane surfaces; with the above design of the lenses, stop ST6, and at least one of the conditions (16)-(25) are satisfied, the lens assembly 6 can have an effective decreased total lens length, an effective decreased F-umber, an effective resisted environment temperature, and an effective corrected aberration. The lens assembly 6 of the present invention can meet the basic operation requirements when the lens assembly 6 only satisfies conditions (4) or (10); the first lens is with negative refractive power and includes a convex surface facing the object side and a concave surface facing the image side; the second lens is with refractive power; the third lens is with refractive power and includes a convex surface facing the object side; the fourth lens is with refractive power and includes a concave surface facing the object side; the fifth lens is with refractive power and includes a convex surface facing the image side; and the sixth lens is with refractive power.

Table 11 shows the optical specification of the lens assembly 6 in FIG. 22.

TABLE 11
Effective Focal Length = 6.67 mm F-number = 1.85
Total Lens Length = 26.06 mm Full Field of View = 57.60 degrees

| | Radius of | | | | Effective | |
|---|---|---|---|---|---|---|
| Surface | Curvature | Thickness | | | Focal | |
| Number | (mm) | (mm) | Nd | Vd | Length (mm) | Remark |
| S61 | 17.56 | 0.95 | 1.76 | 26.52 | −7.86 | L61 |
| S62 | 4.38 | 3.42 | | | | |
| S63 | −5.57 | 0.51 | 1.50 | 66.05 | −39.72 | L62 |
| S64 | −7.96 | 0.10 | | | | |
| S65 | 13.46 | 2.11 | 2.00 | 19.32 | 8.11 | L63 |
| S66 | −19.36 | 3.31 | | | | |
| S67 | ∞ | 0.34 | | | | ST6 |
| S68 | −13.78 | 0.46 | 1.96 | 17.47 | −8.40 | L64 |
| S69 | 7.81 | 2.53 | 1.59 | 68.34 | 22.99 | L65 |
| S610 | −7.00 | 0.10 | | | | |
| S611 | 12.93 | 1.80 | 2.00 | 29.14 | 11.57 | L66 |
| S612 | −109.99 | 9.21 | | | | |
| S613 | ∞ | 0.21 | 1.52 | 64.17 | | OF6 |
| S614 | ∞ | 0.50 | | | | |
| S615 | ∞ | 0.40 | 1.52 | 64.17 | | CG6 |
| S616 | ∞ | 0.13 | | | | |

Table 12 shows the parameters and condition values for conditions (16)-(25) in accordance with the sixth embodiment of the invention. It can be seen from Table 12 that the lens assembly 6 of the sixth embodiment satisfies the conditions (16)-(25).

TABLE 12

| T1 | 0.95 | mm | T2 | 0.51 | mm | T3 | 2.11 | mm |
|---|---|---|---|---|---|---|---|---|
| T4 | 0.46 | mm | T5 | 2.53 | mm | d12 | 3.42 | mm |
| (R11/R41) × T5 | −3.22 | mm | (R21 × R62)^{0.5} | 24.75 | mm | Vd1/T1 | 27.97 | mm⁻¹ |
| (\|f6 × R62\|)^{0.5}/(T3) | 16.93 | | (R11 + R22)/T1 | 10.13 | | f5/(T4/T3) | 106.23 | mm |
| (d12/T2) × R42 | 52.13 | mm | (R11 − R62)/Nd2 | 85.01 | mm | (f2 + f5) × T3 | −35.25 | mm² |
| (R41 × R62)^{0.5} | 38.92 | mm | | | | | | |

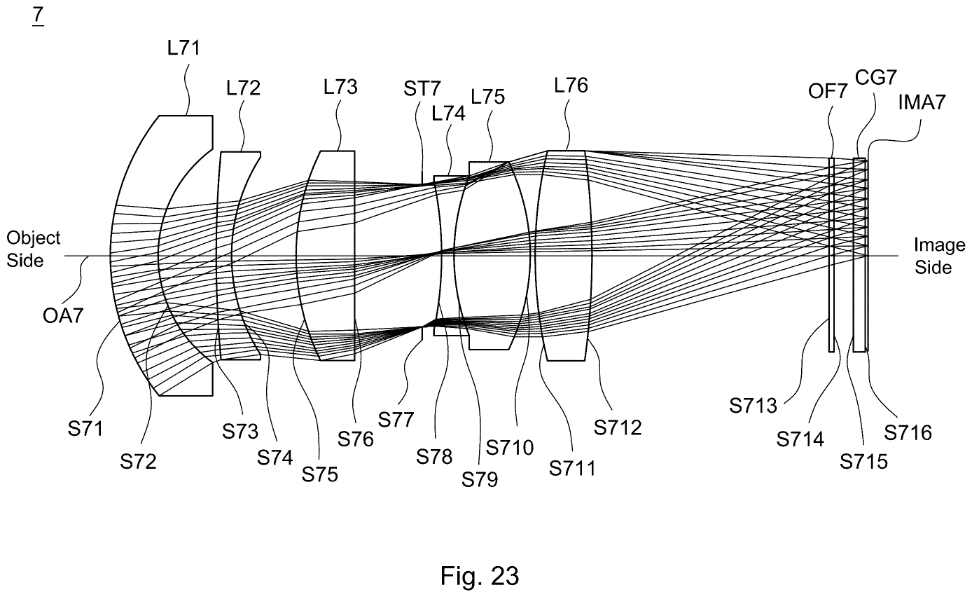

A detailed description of a lens assembly in accordance with a seventh embodiment of the invention is as follows. Referring to FIG. 23, the lens assembly 7 includes a first lens L71, a second lens L72, a third lens L73, a stop ST7, a fourth lens L74, a fifth lens L75, a sixth lens L76, an optical filter OF7, and a cover glass CG7, all of which are arranged in order from an object side to an image side along an optical axis OA7. The combined effective focal length of the combination of the second lens L72 and the third lens L73 is equal to 14.88 mm. In operation, the light from the object side is imaged on an image plane IMA7.

According to the foregoing, wherein: the second lens L72 is a meniscus lens with negative refractive power, wherein the object side surface S73 is a convex surface, the image side surface S74 is a concave surface; the third lens L73 is a plano-convex lens, wherein the image side surface S76 is a plane surface; both of the object side surface S713 and image side surface S714 of the optical filter OF7 are plane surfaces; both of the object side surface S715 and image side surface S716 of the cover glass CG7 are plane surfaces; with the above design of the lenses, stop ST7, and at least one of the conditions (16)-(25) are satisfied, the lens assembly 7 can have an effective decreased total lens length, an effective decreased F-umber, an effective resisted environment temperature, and an effective corrected aberration. The lens assembly 7 of the present invention can meet basic operation requirements when the lens assembly 7 only satisfies conditions (4) or (10); the first lens is with negative refractive power and includes a convex surface facing the object side and a concave surface facing the image side; the second lens is with refractive power; the third lens is with refractive power and includes a convex surface facing the object side; the fourth lens is with refractive power and includes a concave surface facing the object side; the fifth lens is with refractive power and includes a convex surface facing the image side; and the sixth lens is with refractive power.

Table 13 shows the optical specification of the lens assembly 7 in FIG. 23.

TABLE 13
Effective Focal Length = 6.61 mm F-number = 1.85
Total Lens Length = 26.13 mm Full Field of View = 57.20 degrees

| | Radius of | | | | Effective | |
|---|---|---|---|---|---|---|
| Surface | Curvature | Thickness | | | Focal | |
| Number | (mm) | (mm) | Nd | Vd | Length (mm) | Remark |
| S71 | 7.97 | 1.55 | 1.76 | 26.52 | −15.80 | L71 |
| S72 | 4.40 | 2.05 | | | | |
| S73 | 43.89 | 0.49 | 1.50 | 66.05 | −14.07 | L72 |
| S74 | 6.06 | 2.27 | | | | |
| S75 | 8.47 | 1.98 | 2.00 | 19.32 | 8.37 | L73 |
| S76 | ∞ | 2.37 | | | | |
| S77 | ∞ | 0.63 | | | | ST7 |
| S78 | −13.66 | 0.43 | 1.96 | 17.47 | −7.84 | L74 |
| S79 | 6.72 | 2.70 | 1.59 | 68.34 | 25.62 | L75 |
| S710 | −6.86 | 0.10 | | | | |
| S711 | 13.93 | 1.99 | 2.00 | 29.14 | 9.75 | L76 |
| S712 | −30.91 | 8.17 | | | | |
| S713 | ∞ | 0.21 | 1.52 | 64.17 | | OF7 |
| S714 | ∞ | 0.66 | | | | |
| S715 | ∞ | 0.40 | 1.52 | 64.17 | | CG7 |
| S716 | ∞ | 0.13 | | | | |

Table 14 shows the parameters and condition values for conditions (16)-(25) in accordance with the seventh embodiment of the invention. It can be seen from Table 14 that the lens assembly 7 of the seventh embodiment satisfies the conditions (16)-(25).

TABLE 14

| T1 | 1.55 | mm | T2 | 0.49 | mm | T3 | 1.98 | mm |
|---|---|---|---|---|---|---|---|---|
| T4 | 0.43 | mm | T5 | 2.70 | mm | d12 | 2.05 | mm |
| (R11/R41) × T5 | −1.57 | mm | (R21 × R62)^{0.5} | 36.83 | mm | Vd1/T1 | 17.14 | mm⁻¹ |
| (\|f6 × R62\|)^{0.5}/(T3) | 8.75 | | (R11 + R22)/T1 | 9.07 | | f5/(T4/T3) | 119.54 | mm |
| (d12/T2) × R42 | 28.20 | mm | (R11 − R62)/Nd2 | 25.91 | mm | (f2 + f5) × T3 | 22.92 | mm² |
| (R41 × R62)^{0.5} | 20.55 | mm | | | | | | |

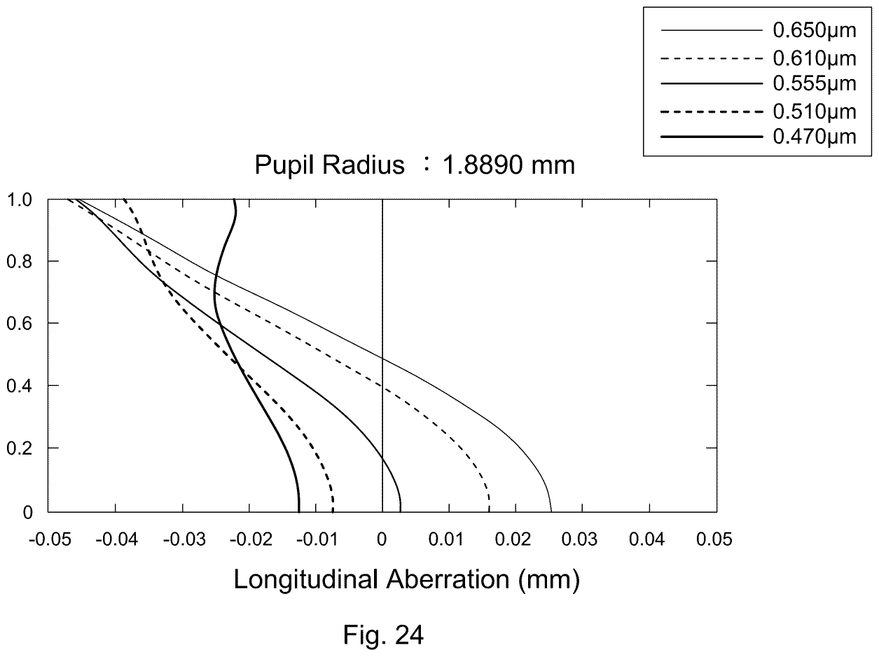

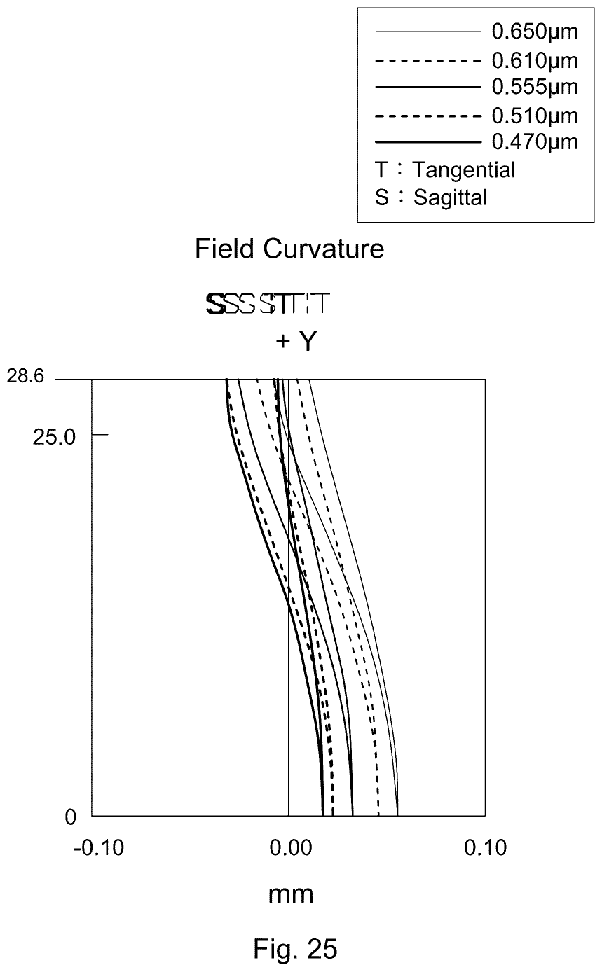

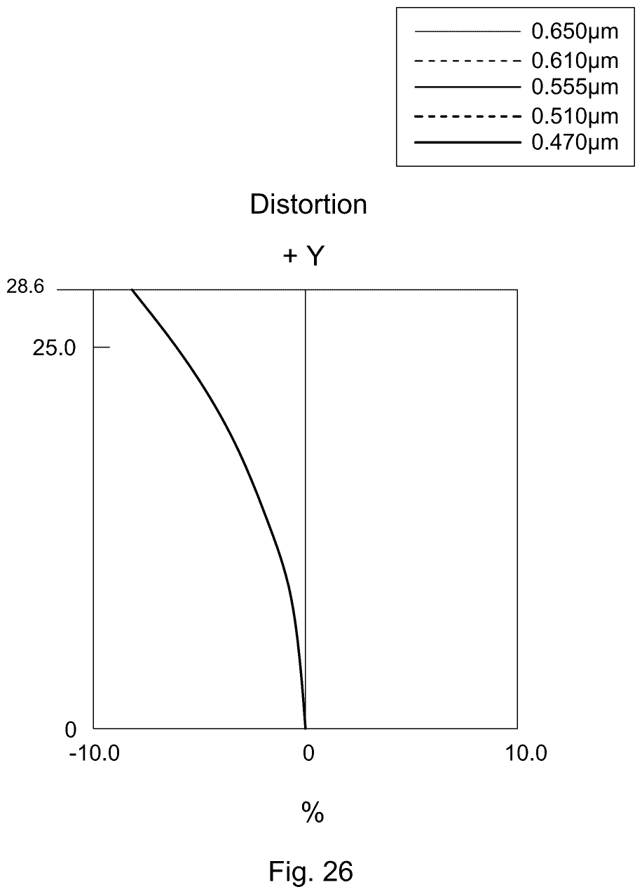

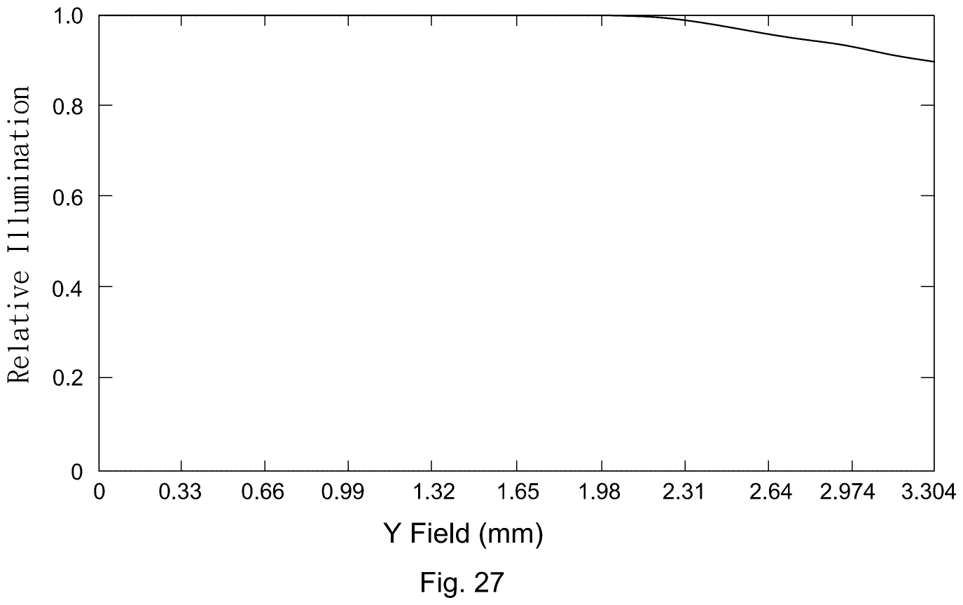

In addition, the lens assembly 7 of the seventh embodiment can meet the requirements of optical performance. It can be seen from FIG. 24 that the longitudinal aberration in the lens assembly 7 of the seventh embodiment ranges from −0.05 mm to 0.03 mm. It can be seen from FIG. 25 that the field curvature of tangential direction and sagittal direction in the lens assembly 7 of the seventh embodiment ranges from −0.04 mm to 0.06 mm. It can be seen from FIG. 26 that the distortion in the lens assembly 7 of the seventh embodiment ranges from −9% to 0%. It can be seen from FIG. 27 that the relative illumination in the lens assembly 7 of the seventh embodiment ranges from 0.90 to 1.0. It is obvious that the longitudinal aberration, the field curvature, and the distortion can be corrected effectively for the lens assembly 7 of the seventh embodiment. Therefore, the lens assembly 7 of the seventh embodiment is capable of good optical performance.

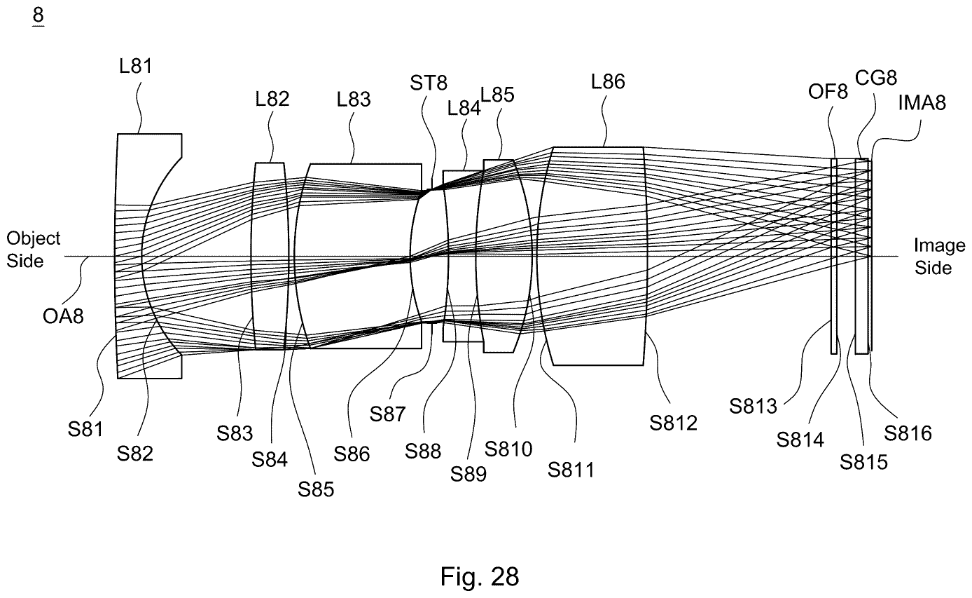

A detailed description of a lens assembly in accordance with an eighth embodiment of the invention is as follows. Referring to FIG. 28, the lens assembly 8 includes a first lens L81, a second lens L82, a third lens L83, a stop ST8, a fourth lens L84, a fifth lens L85, a sixth lens L86, an optical filter OF8, and a cover glass CG8, all of which are arranged in order from an object side to an image side along an optical axis OA8. The combined effective focal length of the combination of the second lens L82 and the third lens L83 is equal to 15.01 mm. In operation, the light from the object side is imaged on an image plane IMA8.

According to the foregoing, wherein: the second lens L82 is a biconvex lens with positive refractive power, wherein the object side surface S83 is a convex surface, the image side surface S84 is a convex surface; the third lens L83 is a meniscus lens, wherein the image side surface S86 is a concave surface; both of the object side surface S813 and image side surface S814 of the optical filter OF8 are plane surfaces; both of the object side surface S815 and image side surface S816 of the cover glass CG8 are plane surfaces; with the above design of the lenses, stop ST8, and at least one of the conditions (16)-(25) are satisfied, the lens assembly 8 can have an effective decreased total lens length, an effective decreased F-umber, an effective resisted environment temperature, and an effective corrected aberration. The lens assembly 8 of the present invention can meet basic operation requirements when the lens assembly 8 only satisfies conditions (4) or (10); the first lens is with negative refractive power and includes a convex surface facing the object side and a concave surface facing the image side; the second lens is with refractive power; the third lens is with refractive power and includes a convex surface facing the object side; the fourth lens is with refractive power and includes a concave surface facing the object side; the fifth lens is with refractive power and includes a convex surface facing the image side; and the sixth lens is with refractive power.

Table 15 shows the optical specification of the lens assembly 8 in FIG. 28.

TABLE 15
Effective Focal Length = 6.71 mm F-number = 1.85
Total Lens Length = 26.05 mm Full Field of View = 57.70 degrees

| | Radius of | | | | Effective | |
|---|---|---|---|---|---|---|
| Surface | Curvature | Thickness | | | Focal | |
| Number | (mm) | (mm) | Nd | Vd | Length (mm) | Remark |
| S81 | 86.01 | 0.88 | 1.57 | 71.30 | −9.77 | L81 |
| S82 | 4.76 | 3.80 | | | | |
| S83 | 35.84 | 1.38 | 2.10 | 17.02 | 24.25 | L82 |
| S84 | −22.22 | 0.08 | | | | |
| S85 | 8.59 | 4.01 | 2.00 | 19.32 | 73.61 | L83 |
| S86 | 7.23 | 0.78 | | | | |
| S87 | ∞ | 0.57 | | | | ST8 |
| S88 | −15.81 | 0.91 | 1.99 | 16.48 | −14.02 | L84 |
| S89 | 15.14 | 2.03 | 1.87 | 40.73 | 9.42 | L85 |
| S810 | −7.72 | 0.10 | | | | |
| S811 | 11.66 | 3.76 | 1.83 | 42.72 | 12.48 | L86 |
| S812 | −87.01 | 6.36 | | | | |
| S813 | ∞ | 0.21 | 1.52 | 64.17 | | OF8 |
| S814 | ∞ | 0.66 | | | | |
| S815 | ∞ | 0.40 | 1.52 | 64.17 | | CG8 |
| S816 | ∞ | 0.13 | | | | |

Table 16 shows the parameters and condition values for conditions (16)-(25) in accordance with the eighth embodiment of the invention. It can be seen from Table 16 that the lens assembly 8 of the eighth embodiment satisfies the conditions (16)-(25).

TABLE 16

| T1 | 0.88 | mm | T2 | 1.38 | mm | T3 | 4.01 | mm |
|---|---|---|---|---|---|---|---|---|
| T4 | 0.91 | mm | T5 | 2.03 | mm | d12 | 3.80 | mm |
| (R11/R41) × T5 | -11.04 | mm | (R21 × R62)^{0.5} | 55.84 | mm | Vd1/T1 | 81.21 | mm⁻¹ |
| (\|f6 × R62\|)^{0.5}/(T3) | 8.22 | | (R11 + R22)/T1 | 72.65 | | f5/(T4/T3) | 41.32 | mm |
| (d12/T2) × R42 | 41.60 | mm | (R11 − R62)/Nd2 | 82.22 | mm | (f2 + f5) × T3 | 134.98 | mm² |
| (R41 × R62)^{0.5} | 37.09 | mm | | | | | | |

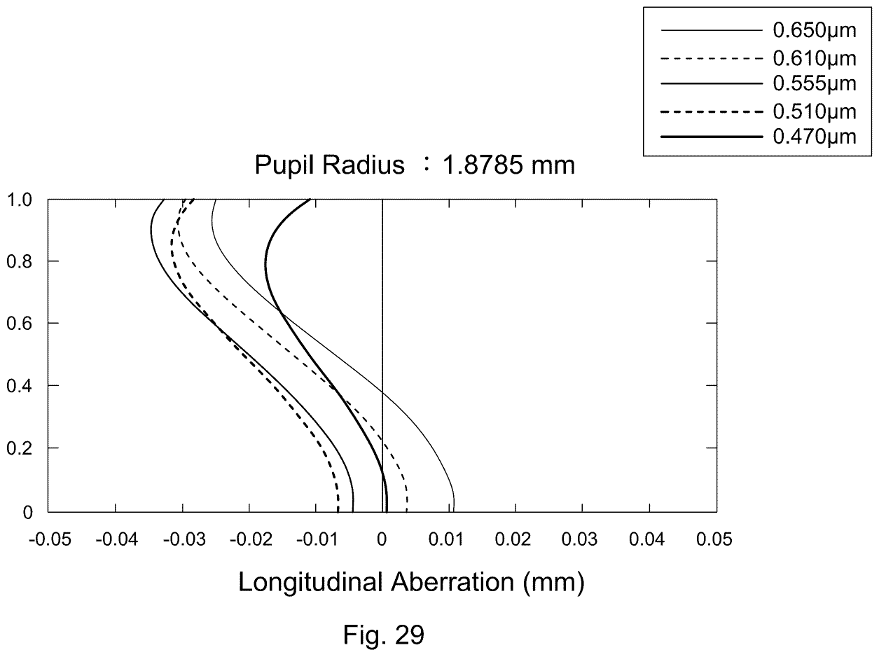

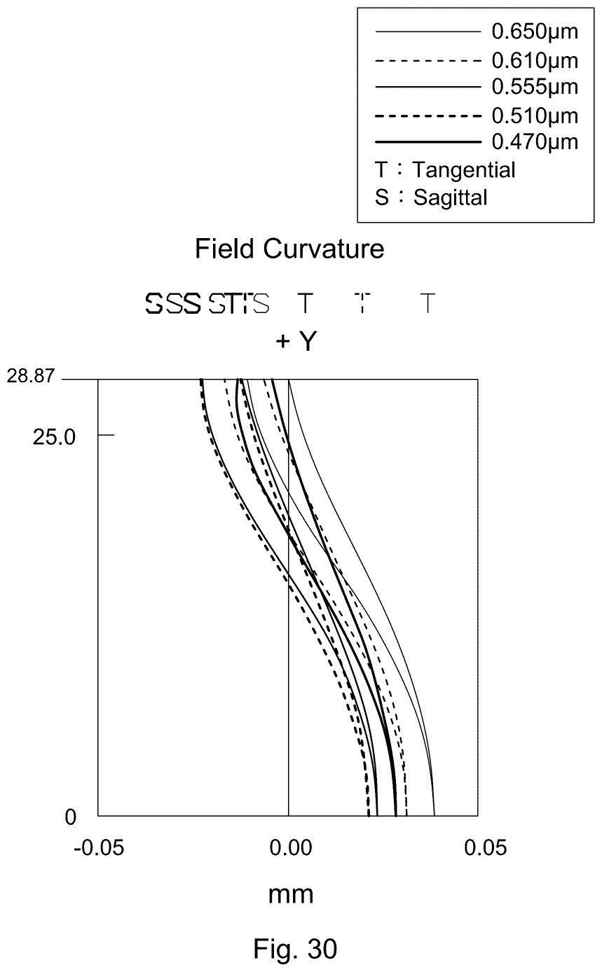

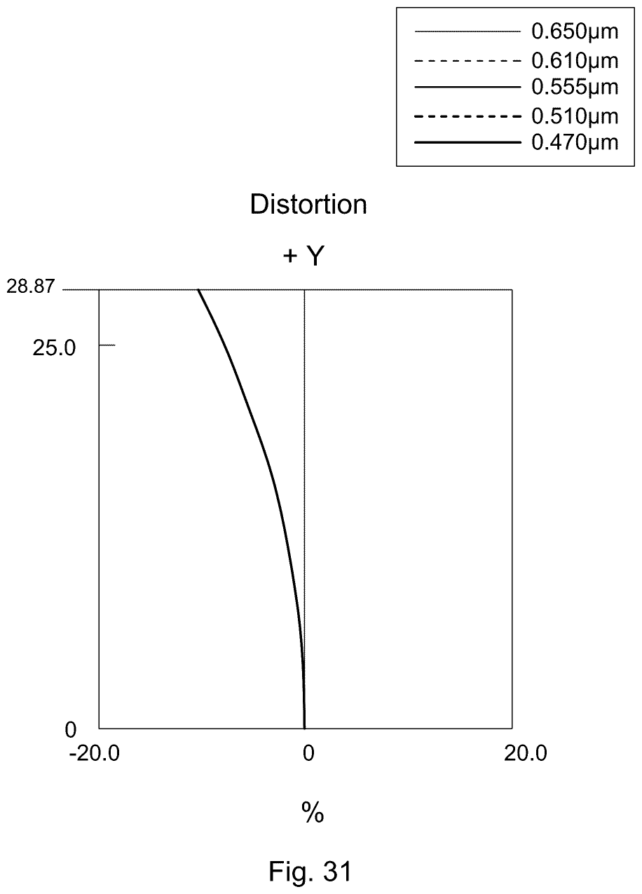

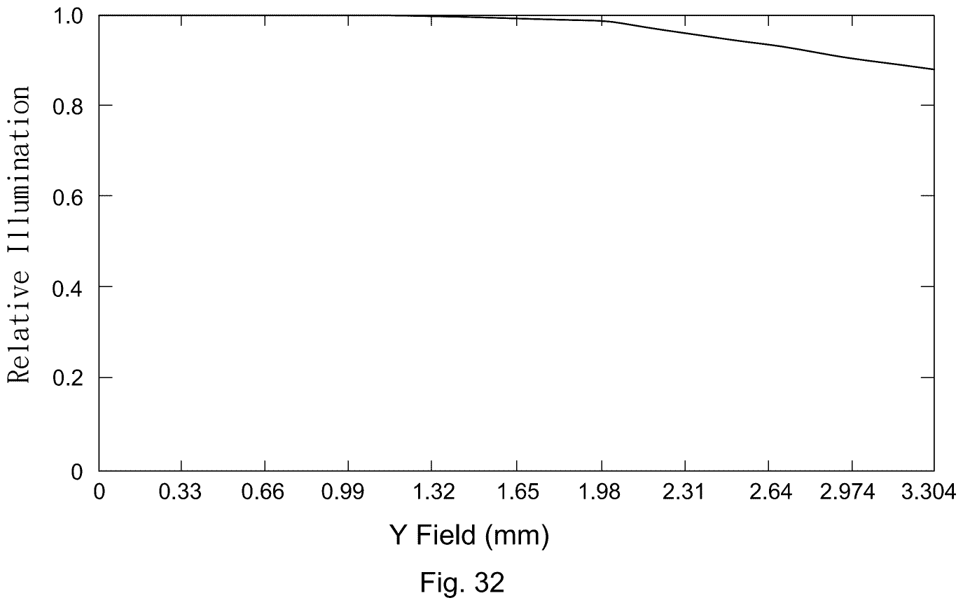

In addition, the lens assembly 8 of the eighth embodiment can meet the requirements of optical performance. It can be seen from FIG. 29 that the longitudinal aberration in the lens assembly 8 of the eighth embodiment ranges from −0.04 mm to 0.015 mm. It can be seen from FIG. 30 that the field curvature of tangential direction and sagittal direction in the lens assembly 8 of the eighth embodiment ranges from −0.03 mm to 0.04 mm. It can be seen from FIG. 31 that the distortion in the lens assembly 8 of the eighth embodiment ranges from −12% to 0%. It can be seen from FIG. 32 that the relative illumination in the lens assembly 8 of the eighth embodiment ranges from 0.88 to 1.0. It is obvious that the longitudinal aberration, the field curvature, and the distortion can be corrected effectively for the lens assembly 8 of the eighth. Therefore, the lens assembly 8 of the eighth embodiment is capable of good optical performance.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lens assembly comprising:
a first lens which is a meniscus lens with negative refractive power and comprises a convex surface facing an object side and a concave surface facing an image side;
a second lens which is with refractive power;
a third lens which is with refractive power;
a fourth lens which is with negative refractive power and comprises a concave surface facing the object side;
a fifth lens which is with positive refractive power and comprises a convex surface facing the image side; and
a sixth lens which is with positive refractive power and comprises a convex surface facing the object side;
wherein the first lens, the second lens, the third lens, the fourth lens, the fifth lens, and the sixth lens are arranged in order from the object side to the image side along an optical axis;
wherein the lens assembly satisfies at least one of following conditions:
$$- 3 \leq ( 3.304 - f \times tan ( θ ) ) \times TTL / ( f \times tan ( θ ) ) \leq - 2.4 ;$$
$$0.7 \leq f 5 / f \leq 1.1 ;$$
$$10 mm \leq f 23 \leq 16 mm ;$$
$$1.11 \leq BFL / f \leq 1.21 ;$$
$$8.32 mm \leq T 4 + T 5 + T 6 \leq 12.16 mm ;$$
$$2.07 \leq R 42 / T 4 \leq 2.93 ;$$
$$8.54 degree / mm \leq FOV / f \leq 8.68 degree / mm ;$$
$$10 < {( \vert f 6 \times R 62 \vert )}^{0.5} / ( T 3 ) < 32 ;$$
$$41 mm < f 5 / ( T 4 / T 3 ) < 120 mm ;$$
wherein f is an effective focal length of the lens assembly, f5 is an effective focal length of the fifth lens, f6 is an effective focal length of the sixth lens, f23 is a combined effective focal length of the combination of the second lens and the third lens, T3 is an interval from an object side surface of the third lens to an image side surface of the third lens along the optical axis, T4 is an interval from an object side surface of the fourth lens to an image side surface of the fourth lens along the optical axis, T5 is an interval from an object side surface of the fifth lens to an image side surface of the fifth lens along the optical axis, T6 is an interval from an object side surface of the sixth lens to an image side surface of the sixth lens along the optical axis, R42 is a radius of curvature of the image side surface of the fourth lens, R62 is a radius of curvature of the image side surface of the sixth lens, TTL is an interval from an object side surface of the first lens to an image plane along the optical axis, BFL is an interval from the image side surface of the sixth lens to the image plane along the optical axis, θ is a field of view when an image height of the lens assembly is equal to 3.304 mm, and FOV is a full field of view of the lens assembly.

2. The lens assembly as claimed in claim 1, wherein:
the fourth lens is a biconcave lens and further comprises another concave surface facing the image side;
the fifth lens is a biconvex lens and further comprises another convex surface facing the object side; and
the sixth lens is a biconvex lens and further comprises another convex surface facing the image side.

3. The lens assembly as claimed in claim 2, wherein the third lens is with positive refractive power and comprises a convex surface facing the object side.

4. The lens assembly as claimed in claim 3, wherein:
the second lens is a meniscus lens with negative refractive power and comprises a convex surface facing the object side and a concave surface facing the image side; and
the third lens is a meniscus lens and further comprises a concave surface facing the image side.

5. The lens assembly as claimed in claim 3, wherein:
the second lens is a meniscus lens with negative refractive power and comprises a convex surface facing the object side and a concave surface facing the image side; and
the third lens is a biconvex lens and further comprises another convex surface facing the image side.

6. The lens assembly as claimed in claim 3, wherein:
the second lens is a meniscus lens with negative refractive power and comprises a concave surface facing the object side and a convex surface facing the image side; and
the third lens is a biconvex lens and further comprises another convex surface facing the image side.

7. The lens assembly as claimed in claim 3, wherein:
the second lens is a meniscus lens with negative refractive power and comprises a convex surface facing the object side and a concave surface facing the image side; and
the third lens is a plano-convex lens and further comprises a plane surface facing the image side.

8. The lens assembly as claimed in claim 3, wherein:
the second lens is a biconvex lens with positive refractive power and comprises a convex surface facing the object side and another convex surface facing the image side; and
the third lens is a meniscus lens and further comprises a concave surface facing the image side.

9. The lens assembly as claimed in claim 2, wherein the second lens is a biconvex lens with positive refractive power and comprises a convex surface facing the object side and another convex surface facing the image side.

10. The lens assembly as claimed in claim 9, wherein the third lens is a biconcave lens with negative refractive power and comprises a concave surface facing the object side and another concave surface facing the image side.

11. The lens assembly as claimed in claim 1, wherein the fourth lens and the fifth lens are cemented or there is no air gap between the fourth lens and the fifth lens.

12. The lens assembly as claimed in claim 11, wherein the second lens and the third lens are cemented or there is no air gap between the second lens and the third lens.

13. The lens assembly as claimed in claim 1, wherein the lens assembly satisfies at least one of following conditions:
$$1.5 \leq ( Vd 1 + Vd 2 ) / \vert Vd 1 - Vd 2 \vert \leq 5.5 ;$$
$$2 \leq ( Vd 2 + Vd 3 ) / \vert Vd 2 - Vd 3 \vert \leq 2.7 ;$$
$$1.5 \leq ( Vd 4 + Vd 5 ) / \vert Vd 4 - Vd 5 \vert \leq 2.5 ;$$
$$1.3 \leq f 6 / f \leq 1.8 ;$$
$$1.5 mm \leq T 4 / Nd 4 \leq 1.9 mm ;$$
$$3.6 mm \leq BFL / Nd 6 \leq 4.1 mm ;$$
$$0.08 \leq ( R 11 - R 12 ) / TTL \leq 0.31 ;$$
$$304.47 \leq TTL / d 56 \leq 318.48 ;$$
$$- 16 mm < ( R 11 / R 41 ) \times T 5 < - 1 mm ;$$
$$12 mm < {( R 21 \times R 62 )}^{0.5} < 141 mm ;$$
$$5 {mm}^{- 1} < Vd 1 / T 1 < 118 {mm}^{- 1} ;$$
$$- 13 < ( R 11 + R 22 ) / T 1 < 80 ;$$
$$28 mm < ( d 12 / T 2 ) \times R 42 < 53 mm ;$$
$$25 mm < ( R 11 - R 62 ) / Nd 2 < 88 mm ;$$
$$- 45 {mm}^{2} < ( f 2 + f 5 ) \times T 3 < 135 {mm}^{2} ;$$
$$19 mm < {( R 41 \times R 62 )}^{0.5} < 39 mm ;$$
wherein f6 is the effective focal length of the sixth lens, f is the effective focal length of the lens assembly, T4 is the interval from the object side surface of the fourth lens to the image side surface of the fourth lens along the optical axis, Vd1 is an Abbe number of the first lens, Vd2 is an Abbe number of the second lens, Vd3 is an Abbe number of the third lens, Vd4 is an Abbe number of the fourth lens, Vd5 is an Abbe number of the fifth lens, Nd4 is a refractive index of the fourth lens, Nd6 is a refractive index of the sixth lens, TTL is the interval from the object side surface of the first lens to the image plane along the optical axis, BFL is the interval from the image side surface of the sixth lens to the image plane along the optical axis, T1 is an interval from the object side surface of the first lens to an image side surface of the first lens along the optical axis, T2 is an interval from an object side surface of the second lens to an image side surface of the second lens along the optical axis, T3 is the interval from the object side surface of the third lens to the image side surface of the third lens along the optical axis, T5 is the interval from the object side surface of the fifth lens to the image side surface of the fifth lens along the optical axis, d56 is an air interval from the image side surface of the fifth lens to the object side surface of the sixth lens along the optical axis, d12 is an air interval from the image side surface of the first lens to the object side surface of the second lens along the optical axis, R11 is a radius of curvature of the object side surface of the first lens, R12 is a radius of curvature of the image side surface of the first lens, R21 is a radius of curvature of the object side surface of the second lens, R22 is a radius of curvature of the image side surface of the second lens, R41 is a radius of curvature of the object side surface of the fourth lens, R42 is the radius of curvature of the image side surface of the fourth lens, R62 is the radius of curvature of the image side surface of the sixth lens, f2 is an effective focal length of the second lens, f5 is the effective focal length of the fifth lens, and Nd2 is a refractive index of the second lens.

14. A lens assembly comprising:
a first lens which is a meniscus lens with negative refractive power and comprises a convex surface facing an object side and a concave surface facing an image side;
a second lens which is with positive refractive power;
a third lens which is with negative refractive power;
a fourth lens which is with negative refractive power and comprises a concave surface facing the object side;
a fifth lens which is with positive refractive power and comprises a convex surface facing the image side; and
a sixth lens which is with positive refractive power and comprises a convex surface facing the object side;
wherein the first lens, the second lens, the third lens, the fourth lens, the fifth lens, and the sixth lens are arranged in order from the object side to the image side along an optical axis.

15. The lens assembly as claimed in claim 14, wherein:
the second lens is a biconvex lens and comprises a convex surface facing the object side and another convex surface facing the image side;
the third lens is a biconcave lens and comprises a concave surface facing the object side and another concave surface facing the image side;
the fourth lens is a biconcave lens and further comprises another concave surface facing the image side;
the fifth lens is a biconvex lens and further comprises another convex surface facing the object side; and
the sixth lens is a biconvex lens and further comprises another convex surface facing the image side.

16. The lens assembly as claimed in claim 14, wherein:
the second lens and the third lens are cemented or there is no air gap between the second lens and the third lens; and
the fourth lens and the fifth lens are cemented or there is no air gap between the fourth lens and the fifth lens.

17. The lens assembly as claimed in claim 14, wherein the lens assembly satisfies at least one of following conditions:
$$- 3 \leq ( 3.304 - f \times tan ( θ ) ) \times TTL / ( f \times tan ( θ ) ) \leq - 2.4 ;$$
$$1.5 \leq ( Vd 1 + Vd 2 ) / \vert Vd 1 - Vd 2 \vert \leq 5.5 ;$$
$$2 \leq ( Vd 2 + Vd 3 ) / \vert Vd 2 - Vd 3 \vert \leq 2.7 ;$$
$$1.5 \leq ( Vd 4 + Vd 5 ) / \vert Vd 4 - Vd 5 \vert \leq 2.5 ;$$
$$0.7 \leq f 5 / f \leq 1.1 ;$$
$$1.3 \leq f 6 / f \leq 1.8 ;$$
$$10 mm \leq f 23 \leq 16 mm ;$$
$$1.5 mm \leq T 4 / Nd 4 \leq 1.9 mm ;$$
$$3.6 mm \leq BFL / Nd 6 \leq 4.1 mm ;$$
$$1.11 \leq BFL / f \leq 1.21 ;$$
$$8.32 mm \leq T 4 + T 5 + T 6 \leq 12.16 mm ;$$
$$0.08 \leq ( R 11 - R 12 ) / TTL \leq 0.31 ;$$
$$2.07 \leq R 42 / T 4 \leq 2.93 ;$$
$$304.47 \leq TTL / d 56 \leq 318.48 ;$$
$$8.54 degree / mm \leq FOV / f \leq 8.68 degree / mm ;$$
$$- 16 mm < ( R 11 / R 41 ) \times T 5 < - 1 mm ;$$
$$12 mm < {( R 21 \times R 62 )}^{0.5} < 141 mm ;$$
$$5 {mm}^{- 1} < Vd 1 / T 1 < 118 {mm}^{- 1} ;$$
$$10 < {( \vert f 6 \times R 62 \vert )}^{0.5} / ( T 3 ) < 32 ;$$
$$- 13 < ( R 11 + R 22 ) / T 1 < 80 ;$$
$$41 mm < f 5 / ( T 4 / T 3 ) < 120 mm ;$$
$$28 mm < ( d 12 / T 2 ) \times R 42 < 53 mm ;$$
$$25 mm < ( R 11 - R 62 ) / Nd 2 < 88 mm ;$$
$$- 45 {mm}^{2} < ( f 2 + f 5 ) \times T 3 < 135 {mm}^{2} ;$$
$$19 mm < {( R 41 \times R 62 )}^{0.5} < 39 mm ;$$
wherein f is an effective focal length of the lens assembly, f5 is an effective focal length of the fifth lens, f6 is an effective focal length of the sixth lens, f23 is a combined effective focal length of the combination of the second lens and the third lens, T3 is an interval from an object side surface of the third lens to an image side surface of the third lens along the optical axis, T4 is an interval from an object side surface of the fourth lens to an image side surface of the fourth lens along the optical axis, T5 is an interval from an object side surface of the fifth lens to an image side surface of the fifth lens along the optical axis, T6 is an interval from an object side surface of the sixth lens to an image side surface of the sixth lens along the optical axis, R42 is a radius of curvature of the image side surface of the fourth lens, R62 is a radius of curvature of the image side surface of the sixth lens, TTL is an interval from an object side surface of the first lens to an image plane along the optical axis, BFL is an interval from the image side surface of the sixth lens to the image plane along the optical axis, θ is a field of view when an image height of the lens assembly is equal to 3.304 mm, FOV is a full field of view of the lens assembly, Vd1 is an Abbe number of the first lens, Vd2 is an Abbe number of the second lens, Vd3 is an Abbe number of the third lens, Vd4 is an Abbe number of the fourth lens, Vd5 is an Abbe number of the fifth lens, Nd4 is a refractive index of the fourth lens, Nd6 is a refractive index of the sixth lens, T1 is an interval from the object side surface of the first lens to an image side surface of the first lens along the optical axis, T2 is an interval from an object side surface of the second lens to an image side surface of the second lens along the optical axis, d56 is an air interval from the image side surface of the fifth lens to the object side surface of the sixth lens along the optical axis, d12 is an air interval from the image side surface of the first lens to the object side surface of the second lens along the optical axis, R11 is a radius of curvature of the object side surface of the first lens, R12 is a radius of curvature of the image side surface of the first lens, R21 is a radius of curvature of the object side surface of the second lens, R22 is a radius of curvature of the image side surface of the second lens, R41 is a radius of curvature of the object side surface of the fourth lens, f2 is an effective focal length of the second lens, and Nd2 is a refractive index of the second lens.
